(19) United States
(12) Patent Application Publication
(10) Pub. No.: US 2025/0163670 A1
(43) Pub. Date: May 22, 2025

(54) WORKING MACHINE

(71) Applicant: Kubota Corporation, Osaka-shi (JP)

(72) Inventor: Takuma SAI, Sakai-shi (JP)

(21) Appl. No.: 18/946,254

(22) Filed: Nov. 13, 2024

(30) Foreign Application Priority Data
Nov. 16, 2023 (JP) 2023-195085
Nov. 16, 2023 (JP) 2023-195086
Nov. 16, 2023 (JP) 2023-195087
Nov. 16, 2023 (JP) 2023-195088

(51) Int. Cl. E02F 3/43; E02F 3/32; E02F 9/22; E02F 9/26; F15B 13/044

(52) U.S. Cl. CPC E02F 3/437; E02F 3/325; E02F 9/2203; E02F 9/264; F15B 13/044; E02F 9/2285; E02F 9/2292; E02F 9/2296

(57) ABSTRACT

A working machine includes a boom rotatably coupled to a machine body, an arm rotatably coupled to the boom, a bucket coupled to the arm and including an edge portion, and a controller. The controller is configured or programmed to, in performing a first process to perform excavation along a plane at a target excavation depth, set a first target angular velocity of the arm and a second target angular velocity of the boom based on a distance between the edge portion in a movement start position and the target excavation depth, the first target angular velocity corresponding to a time elapsed from a start of movement of the arm, the second target angular velocity corresponding to a time elapsed from a start of movement of the boom, and control rotation of the arm and the boom based on the set first and second target angular velocities.

### CROSS REFERENCE TO RELATED APPLICATIONS

This application claims the benefit of priority to Japanese Patent Application No. 2023-195086 filed on Nov. 16, 2023, to Japanese Patent Application No. 2023-195085 filed on Nov. 16, 2023, to Japanese Patent Application No. 2023-195087 filed on Nov. 16, 2023, and to Japanese Patent Application No. 2023-195088 filed on Nov. 16, 2023. The entire contents of these applications are hereby incorporated herein by reference.

### BACKGROUND OF THE INVENTION

### 1. Field of the Invention

The present invention relates to working machines each including a shovel to excavate earth.

### 2. Description of the Related Art

In the related art, a work machine that controls an excavation operation in accordance with a measurement result of an excavation depth by a bucket is known (see, for example, Japanese Unexamined Patent Application Publication No. 2007-061042).

### SUMMARY OF THE INVENTION

Although an excavation depth is controlled by a combined operation of an arm and a boom, the boom and the arm have different response characteristics at the start of operation, and thus, depending on the position of a front end of a bucket at the start, it may sometimes be difficult to accurately control the position of the front end of the bucket at a target height. For example, when the edge of the bucket is to be moved horizontally along a plane at the target depth by causing the boom and the bucket to start moving when the edge is near the target depth (when performing so-called horizontal dragging), there may be a case where the upward movement of the boom is delayed with respect to the crowding action of the arm, resulting in digging deeper than the target excavation depth.

In view of this, example embodiments of the present invention provide working machines each of which makes it possible to eliminate or reduce the likelihood of excavation deeper than an expected target excavation depth when excavating earth.

A working machine according to one or more example embodiments of the present invention includes a machine body, a boom coupled to the machine body such that the boom is rotatable about a first lateral shaft, an arm coupled to a distal portion of the boom such that the arm is rotatable about a second lateral shaft, a bucket coupled to a distal portion of the arm and including an edge portion located away from a junction of the bucket and the arm, the edge portion being a leading edge when the bucket excavates earth, and a controller configured or programmed to control rotation of the boom and the arm, wherein the controller is configured or programmed to, in performing a first process in which the controller causes the arm to rotate about the second lateral shaft toward the boom while causing the boom to rotate about the first lateral shaft to move up to perform excavation along a plane at a target excavation depth, set a first target angular velocity of the arm and a second target angular velocity of the boom based on a distance between the edge portion in a movement start position and the target excavation depth, the first target angular velocity being a target angular velocity corresponding to a period of time elapsed from a start of movement of the arm, the second target angular velocity being a target angular velocity corresponding to a period of time elapsed from a start of movement of the boom, and control rotation of the arm and the boom based on the set first target angular velocity and the set second target angular velocity.

The controller may be configured or programmed to set the first target angular velocity such that, as the distance becomes smaller, an initial angular velocity of the arm becomes smaller and an angular acceleration during a predetermined first period of time elapsed from the start of movement becomes greater, and set the second target angular velocity according to the first target angular velocity.

The controller may be configured or programmed to set the first target angular velocity such that the first target angular velocity increases during the first period of time elapsed from the start of movement and is constant after the first period of time has elapsed.

The controller may be configured or programmed to set the second target angular velocity such that the second target angular velocity increases during a second period of time elapsed from the start of movement and is constant after the second period of time has elapsed, and set the second period of time such that the second period of time becomes longer as the distance becomes greater.

The working machine may further include an arm cylinder to extend and retract by receiving and discharging hydraulic fluid to rotate the arm, a boom cylinder to extend and retract by receiving and discharging hydraulic fluid to rotate the boom, an arm control valve including a solenoid to switch supplying and discharging hydraulic fluid to and from the arm cylinder and to adjust a flow rate of hydraulic fluid based on a current value inputted thereto, and a boom control valve including a solenoid to switch supplying and discharging hydraulic fluid to and from the boom cylinder and to adjust a flow rate of hydraulic fluid based on a current value inputted thereto. The controller may be configured or programmed to supply a current corresponding to the first target angular velocity to the solenoid of the arm control valve and supply a current corresponding to the second target angular velocity to the solenoid of the boom control valve.

The working machine may further include a hydraulic pump to deliver hydraulic fluid toward the arm cylinder and the boom cylinder, and a driving source to drive the hydraulic pump. The controller may be configured or programmed to, when performing the first process, set the first target angular velocity and the second target angular velocity based on a distance between the edge portion and the target excavation depth and an output of the driving source at a time of receipt of an instruction to actuate the arm and the boom.

The driving source may be operable to switch a power mode thereof between a low-power mode in which the driving source produces output in a low-power range included in a power range thereof, and a high-power mode in which the driving source produces output higher than the low-power range included in the power range thereof. The controller may be configured or programmed to, when performing the first process, set the first target angular velocity and the second target angular velocity based on the distance between the edge portion and the target excavation depth and the power mode of the driving source at the time of receipt of an instruction to actuate the arm and the boom.

The controller may be configured or programmed to set an initial angular velocity of the arm using Equation (1) below, set a rate of increase of an angular velocity of the arm during a predetermined period of time elapsed from the start of movement using Equation (2) below, and set the first target angular velocity during the predetermined period of time elapsed from the start of movement using Equation (3) below:

Initial angular velocity ωs=(P×k)−Nd Equation (1)

Rate of increase α of angular velocity=(ωmax−ωs)/Ta Equation (2)

First target acceleration=α×Tb+ωs Equation (3),
where P represents the distance between the edge portion and the target excavation depth at a time of the start of movement,
k represents a preset coefficient,
Nd represents a difference of the output of the driving source from an output in the high-power mode,
ωmax represents an estimated maximum angular velocity of the arm corresponding to the output of the driving source,
Ta represents time taken to reach the maximum angular velocity, and
Tb represents the period of time elapsed from the start of movement.

The controller may be configured or programmed to derive the second target angular velocity by multiplying the first target angular velocity by a predetermined reflection coefficient set such that the second target angular velocity is lower than the first target angular velocity.

The controller may be configured or programmed to include a memory and/or a storage to store (i) a plurality of combinations of an initial difference and initial angle information and (ii) set values of angular acceleration of the boom about the first lateral shaft that correspond to the plurality of combinations, the initial difference being a distance between a target excavation surface and the edge portion in the movement start position in the first process, the target excavation surface being a plane corresponding to the target excavation depth, the first process being a process in which the controller causes the arm to rotate about the second lateral shaft toward the boom while causing the boom to rotate about the first lateral shaft to move up to perform excavation along the plane at the target excavation depth, the initial angle information being correlated with an angle of the arm relative to the target excavation surface when the edge portion is in the movement start position, and set, based on one of the set values that corresponds to a corresponding combination of the initial difference and the initial angle information when the edge portion is in the movement start position, an angular acceleration of the boom about the first lateral shaft during a predetermined period of time elapsed from the start of rotation, and control rotation of the boom based on the set angular acceleration.

A working machine according to one or more example embodiments of the present invention includes a machine body, a boom coupled to the machine body such that the boom is rotatable about a first lateral shaft, an arm coupled to a distal portion of the boom such that the arm is rotatable about a second lateral shaft, a bucket coupled to a distal portion of the arm and including an edge portion located away from a junction of the bucket and the arm, the edge portion being a leading edge when the bucket excavates earth, and a controller configured or programmed to control rotation of the boom and the arm, wherein the controller is configured or programmed to include a memory and/or a storage to store (i) a plurality of combinations of an initial difference and initial angle information and (ii) set values of angular acceleration of the boom about the first lateral shaft that correspond to the plurality of combinations, the initial difference being a distance between a target excavation surface and the edge portion in a movement start position in a first process, the target excavation surface being a plane corresponding to a target excavation depth, the first process being a process in which the controller causes the arm to rotate about the second lateral shaft toward the boom while causing the boom to rotate about the first lateral shaft to move up to perform excavation along a plane at the target excavation depth, the initial angle information being correlated with an angle of the arm in the movement start position relative to the target excavation surface, and set, based on one of the set values that corresponds to a corresponding combination of the initial difference and the initial angle information when the arm is in the movement start position, an angular acceleration of the boom about the first lateral shaft during a predetermined period of time elapsed from a start of movement, and control rotation of the boom based on the set angular acceleration.

The initial angle information may include an initial tangent angle indicating an angle, relative to the target excavation surface when the edge portion is in the movement start position, of a tangent to an imaginary circle defined by a path of movement of the edge portion of the bucket around the second lateral shaft.

The set values of angular acceleration stored in the memory and/or the storage may be set greater for smaller initial differences and set greater for larger initial tangent angles.

The working machine may further include a boom angle detector to detect an angle of rotation of the boom about the first lateral shaft with respect to the machine body, and an arm angle detector to detect an angle of rotation of the arm about the second lateral shaft with respect to the boom. The controller may be configured or programmed to calculate the initial angle information based on a detection result from the boom angle detector, a detection result from the arm angle detector, and the target excavation depth.

The bucket may be coupled to the distal portion of the arm such that the bucket is rotatable about a third lateral shaft. The working machine may include a bucket angle detector to detect an angle of rotation of the bucket about the third lateral shaft with respect to the arm. The controller may be configured or programmed to calculate the initial angle information based on a detection result from a boom angle detector, a detection result from an arm angle detector, a detection result from the bucket angle detector, and the target excavation depth.

The controller may be configured or programmed to, if a value of the angular acceleration corresponding to a combination of the actual initial difference and the actual initial angle information when the arm is in the movement start position is other than the set values stored in the memory and/or the storage, interpolate a set value of the angular acceleration corresponding to the combination of the actual initial difference and the initial angle information based on the plurality of combinations of the initial difference and the initial angle information stored in the memory and/or the storage and set values of the angular velocity that correspond to the plurality of combinations.

The bucket may be coupled to the distal portion of the arm such that the bucket is rotatable about a third lateral shaft, and includes the edge portion located away from the junction of the bucket and the arm, the edge portion being the leading edge when the bucket excavates earth, the bucket being operable to rotate about the third lateral shaft in one direction to swing toward the machine body such that the edge portion, which is the leading edge, excavates earth and being operable to rotate about the third lateral shaft in an opposite direction to be in a posture to discharge earth. The controller may be configured or programmed to restrict rotation of the bucket in the one direction when (i) a distance between a target excavation surface which is a plane corresponding to the target excavation depth and an axis of the third lateral shaft is shorter than a distance between the axis of the third lateral shaft and the edge portion and (ii) the edge portion is located in one of two regions separated by an imaginary planar first boundary that is farther away from the machine body than the other of the two regions, the first boundary being perpendicular to the target excavation surface and including the axis of the third lateral shaft.

A working machine according to one or more example embodiments of the present invention includes a machine body, a boom coupled to the machine body such that the boom is rotatable about a first lateral shaft, an arm coupled to a distal portion of the boom such that the arm is rotatable about a second lateral shaft, a bucket coupled to a distal portion of the arm such that the bucket is rotatable about a third lateral shaft and including an edge portion located away from a junction of the bucket and the arm, the edge portion being a leading edge when the bucket excavates earth, the bucket being operable to rotate about the third lateral shaft in one direction to swing toward the machine body such that the edge portion, which is the leading edge, excavates earth and being operable to rotate about the third lateral shaft in an opposite direction to be in a posture to discharge earth, and a controller configured or programmed to control rotation of the boom and the arm, wherein the controller is configured or programmed to restrict rotation of the bucket in the one direction when (i) a distance between a target excavation surface which is a plane corresponding to a target excavation depth and an axis of the third lateral shaft is shorter than a distance between the axis of the third lateral shaft and the edge portion and (ii) the edge portion is located in one of two regions separated by an imaginary planar first boundary that is farther away from the machine body than the other of the two regions, the first boundary being perpendicular to the target excavation surface and including the axis of the third lateral shaft.

The controller may be configured or programmed to not restrict the rotation of the bucket in the one direction when the edge portion is positioned in the other of the two regions that is closer to the machine body than the first boundary or when the edge portion is positioned in the other of the two regions closer to the machine body than the first boundary and higher than the target excavation surface.

The controller may be configured or programmed to not restrict the rotation of the bucket in the one direction when the distance between the target excavation surface and the axis of the third lateral shaft is longer than the distance between the axis of the third lateral shaft and the edge portion.

The above and other elements, features, steps, characteristics and advantages of the present invention will become more apparent from the following detailed description of the example embodiments with reference to the attached drawings.

### BRIEF DESCRIPTION OF THE DRAWINGS

A more complete appreciation of example embodiments of the present invention and many of the attendant advantages thereof will be readily obtained as the same becomes better understood by reference to the following detailed description when considered in connection with the accompanying drawings described below.

FIG. 1 is a side view of a working machine according to a first example embodiment of the present invention.

FIG. 2 is a schematic block diagram of a hydraulic system of the working machine according to the first example embodiment.

FIG. 3 is a schematic cross-sectional view of an example of a control valve that is included in a control valve of the working machine according to the first example embodiment.

FIG. 4 is a schematic block diagram of an electrical (signal) system including a controller of the working machine according to the first example embodiment.

FIG. 5 is a flowchart of a former process of a depth limiting function of the working machine according to the first example embodiment.

FIG. 6 is a conceptual diagram of a table (a map) illustrating a relationship of information (data) that is used in the former process of the working machine according to the first example embodiment.

FIG. 7 is a graph illustrating a target angular velocity of an arm and a target angular velocity of a boom that are set in the former process of the depth limiting function of the working machine according to the first example embodiment and is a graph illustrating a low-rotation, low-power mode in the case where an amount of movement of an edge portion of a bucket is large.

FIG. 8 is a graph illustrating the target angular velocity of the arm and the target angular velocity of the boom that are set in the former process of the depth limiting function of the working machine according to the first example embodiment and is a graph illustrating the low-rotation, low-power mode in the case where the amount of movement of the edge portion of the bucket is small.

FIG. 9 is a graph illustrating the target angular velocity of the arm and the target angular velocity of the boom that are set in the former process of the depth limiting function of the working machine according to the first example embodiment and is a graph illustrating a high-rotation, high-power mode in the case where the amount of movement of the edge portion of the bucket is large.

FIG. 10 is a graph illustrating the target angular velocity of the arm and the target angular velocity of the boom that are set in the former process of the depth limiting function of the working machine according to the first example embodiment and is a graph illustrating the high-rotation, high-power mode in the case where the amount of movement of the edge portion of the bucket is small.

FIG. 11 is a schematic diagram illustrating a calculator that is included in the controller of the working machine according to the first example embodiment.

FIG. 12 is a diagram illustrating a region in which an operation of the bucket of the working machine according to the first example embodiment is restricted.

FIG. 13 is a graph illustrating an angular velocity of the bucket of the working machine according to the first example embodiment in the region in which the operation of the bucket is restricted.

FIG. 14 is a diagram illustrating information (data) that is used in a former process of a working machine according to a second example embodiment of the present invention.

FIG. 15 is a conceptual diagram of a table (a map) illustrating a relationship of the information (data) used in the former process of the working machine according to the second example embodiment.

FIG. 16 is a flowchart of the former process of the depth limiting function of the working machine according to the second example embodiment.

### DETAILED DESCRIPTION OF THE EXAMPLE EMBODIMENTS

Example embodiments will now be described with reference to the accompanying drawings, wherein like reference numerals designate corresponding or identical elements throughout the various drawings. The drawings are to be viewed in an orientation in which the reference numerals are viewed correctly.

### First Example Embodiment

A working machine according to an example embodiment of the present invention will be described below with reference to the drawings.

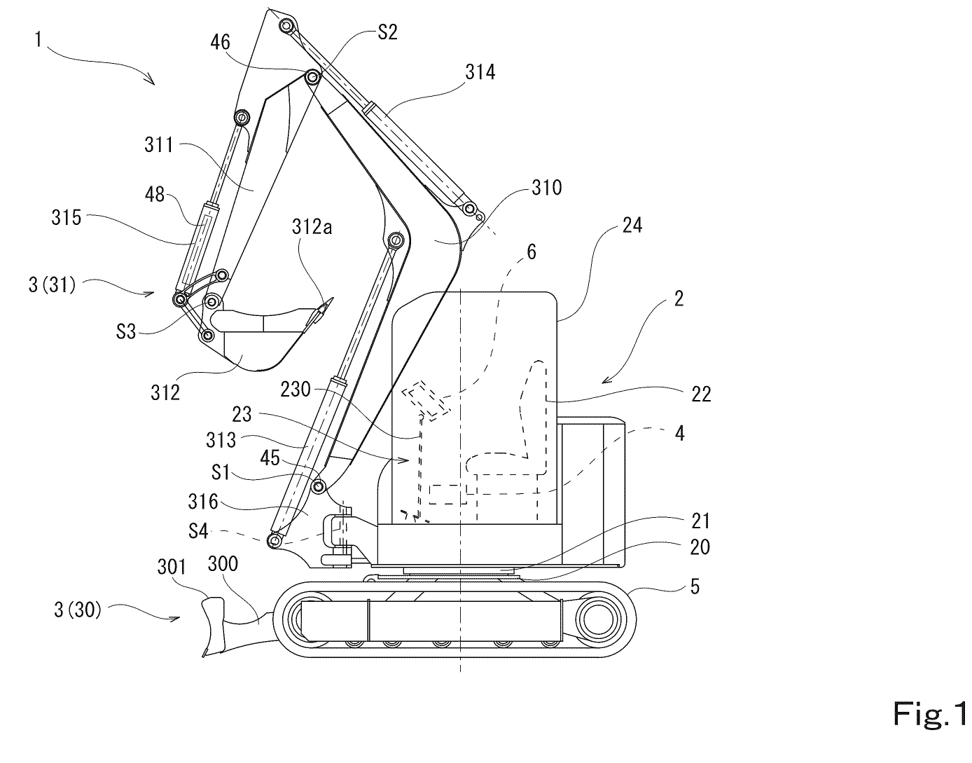

As illustrated in FIG. 1, a working machine 1 includes a machine body 2, a working device 3 supported by the machine body 2, and a controller 4 configured or programmed to control at least an operation of the working device 3. The working machine 1 further includes a traveling device 5 that supports the machine body 2 such that the machine body 2 can travel. In addition to the above-described configuration, the working machine 1 according to the present example embodiment includes an input device 6 through which an operator inputs necessary information.

The machine body 2 includes a traveling base 20 and a swivel base 21. The traveling base 20 is connected to the traveling device 5, and the swivel base 21 can turn around an axis extending in the vertical direction and is fixed on the traveling base 20. The machine body 2 further includes an operator's seat 22 where the operator sits, a manipulator 23 by which the operator operates the working machine 1, an operator's seat protector 24 that protects the operator's seat 22 (the operator), and the like, and these are arranged on the swivel base 21. The operator's seat protector 24 of the present example embodiment is a cabin that covers the operator's seat 22 and the manipulator 23.

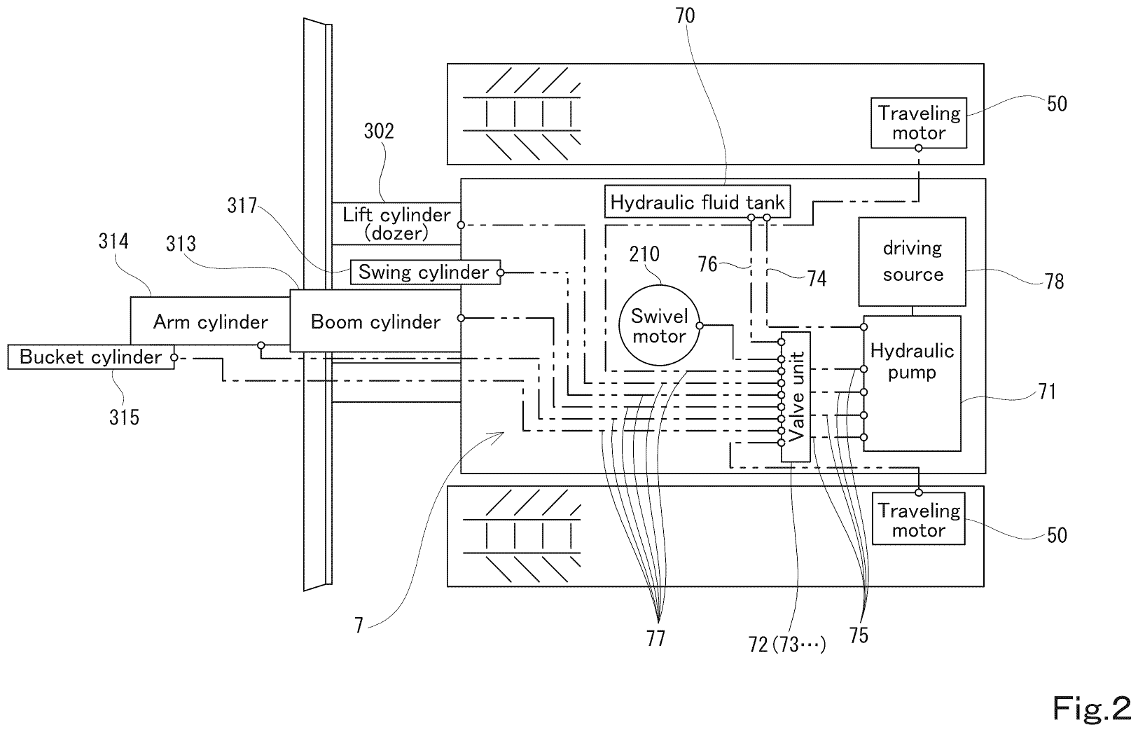

The working machine 1 of the present example embodiment includes a dozer 30 and a shovel 31 each serving as the working device 3. The dozer 30 includes a lift arm 300 that is pivotally supported by the traveling base 20, a blade 301 that is attached to an end portion of the lift arm 300, and a lift cylinder 302 (see FIG. 2) that raises and lowers the lift arm 300. The dozer 30 extends toward the front of the machine body 2.

The shovel 31 includes a boom 310, an arm 311, and a bucket 312. The boom 310 is coupled to the machine body 2 (the swivel base 21 in the present example embodiment) so as to be rotatable around a first lateral shaft S1. The arm 311 is coupled to an end portion of the boom 310 so as to be rotatable around a second lateral shaft S2. The bucket 312 is coupled to an end portion of the arm 311 so as to be rotatable around a third lateral shaft S3 and includes an edge portion 312a that is located at a position away from the position where the bucket 312 is coupled to the arm 311 (the third lateral shaft S3) and that serves as a leading edge when excavating earth.

The shovel 31 further includes actuators 313, 314, and 315 that cause the boom 310, the arm 311, and the bucket 312 to rotate around the lateral shafts S1, S2, and S3, respectively. More specifically, the shovel 31 includes, as the actuators 313, 314, and 315, a boom cylinder 313 that causes the boom 310 to rotate around the first lateral shaft S1 (to swing in the vertical direction), an arm cylinder 314 that causes the arm 311 to rotate around the second lateral shaft S2, and a bucket cylinder 315 that causes the bucket 312 to rotate around the third lateral shaft S3.

In the working machine 1 of the present example embodiment, the shovel 31 includes a device support body 316 that is coupled to the swivel base 21 so as to be rotatable around a vertical shaft S4. The boom 310 is coupled to the device support body 316 so as to be rotatable around the first lateral shaft S1. Accordingly, the working machine 1 (the shovel 31) includes a swing cylinder 317 (see FIG. 2) that causes the boom 310 to rotate (swing) around the vertical shaft S4, which extends in the vertical direction, via the device support body 316.

In the present example embodiment, the boom cylinder 313, the arm cylinder 314, the bucket cylinder 315, and the swing cylinder 317 are hydraulic cylinders. Accordingly, as illustrated in FIG. 2, the working machine 1 includes a hydraulic system 7 that supplies and discharges a hydraulic fluid to and from the lift cylinder 302, the boom cylinder 313, the arm cylinder 314, the bucket cylinder 315, and the swing cylinder 317.

The working machine 1 includes a traveling motor 50 that drives the traveling device 5 and a swivel motor 210 that drives the swivel base 21. In the present example embodiment, the traveling motor 50 and the swivel motor 210 are hydraulic motors, for example. Accordingly, the hydraulic system 7 also supplies and discharges the hydraulic fluid to and from the traveling motor 50 and the swivel motor 210.

Specifically describing the hydraulic system 7, the hydraulic system 7 includes a hydraulic fluid tank 70 that stores the hydraulic fluid, a hydraulic pump 71 that supplies (delivers) the hydraulic fluid to the actuators 313, 314, 315, 317, 50, and 210, and a valve unit 72 that changes a flow rate of the hydraulic fluid and a flow path of the hydraulic fluid.

More specifically, the hydraulic system 7 includes the hydraulic fluid tank 70, the hydraulic pump 71, the valve unit 72, a primary supply pipe 74, a secondary supply pipe 75, a drain pipe 76, and a plurality of pairs of connecting pipes 77. The hydraulic pump 71 delivers the hydraulic fluid stored in the hydraulic fluid tank 70 toward the actuators. The valve unit 72 changes the flow path of the hydraulic fluid and performs other related operations. The primary supply pipe 74 connects the hydraulic fluid tank 70 and the hydraulic pump 71 to each other and supplies the hydraulic fluid stored in the hydraulic fluid tank 70 to the hydraulic pump 71. The secondary supply pipe 75 connects the hydraulic pump 71 and the valve unit 72 to each other and supplies the hydraulic fluid delivered from the hydraulic pump 71 to the valve unit 72. The drain pipe 76 connects the hydraulic fluid tank 70 and the valve unit 72 to each other and returns the hydraulic fluid from the valve unit 72 to the hydraulic fluid tank 70. The plurality of pairs of connecting pipes 77 connect the valve unit 72 to the actuators. In each pair of the connecting pipes 77, as a result of the flow path of the hydraulic fluid being changed by the valve unit 72, one of the connecting pipes 77 serves as a supply line that supplies the hydraulic fluid from the hydraulic pump 71 to the corresponding actuator, and the other connecting pipe 77 serves as a discharge line that discharges the hydraulic fluid from the actuator. In FIG. 2, each pair of connection pipes 77 is illustrated as a single system.

The hydraulic fluid tank 70 is configured to be capable of storing an amount of the hydraulic fluid required to cause the actuators to operate. In the present example embodiment, the hydraulic pump 71 is a multiple hydraulic pump. More specifically, the hydraulic pump 71 includes a main pump, a sub-pump, and a pilot pump, and is a multiple hydraulic pump in which these pumps are arranged in series. FIG. 2 illustrates a system that is connected to the main pump as the hydraulic system 7.

The main pump includes a fixed displacement gear pump or the variable displacement hydraulic pump 71. The hydraulic fluid delivered from the main pump is supplied to the actuators to operate the actuators. More specifically, the main pump causes the boom cylinder 313, the arm cylinder 314, the bucket cylinder 315, and the swing cylinder 317, which are the actuators (hydraulic actuators).

The sub-pump is the hydraulic pump 71 to increase the amount of the hydraulic fluid to be supplied to the actuators, which are caused to operate by the main pump. The pilot pump is the hydraulic pump 71 to supply the hydraulic fluid for pilot signals to a control valve 73 that controls the actuators, which are caused to operate by the main pump. The sub-pump and the pilot pump each include, for example, a fixed displacement gear pump.

The working machine 1 (the hydraulic system 7) includes a driving source 78 that drives the hydraulic pump 71. In the present example embodiment, an internal combustion engine is used as the driving source 78, for example. More specifically, a diesel engine is used as the driving source 78. The driving source 78 achieves a high output at a high rotational speed and a low output at a low rotational speed. An output of the driving source 78 increases proportionally as the rotational speed increases from a low rotational speed to a high rotational speed. The output of the driving source 78 varies depending on the specifications (performance) with some specifications exhibiting a linear increase as the rotational speed increases (high speed), while others exhibit a quadratic increase. For convenience of description, the output of the driving source 78 is assumed to increase linearly as the rotational speed increases to a high speed.

In the present example embodiment, the power mode of the driving source 78 can be switched between a low-power mode (LOW mode) in which the driving source 78 produces output in a low-power range within its power range and a high-power mode (HI mode) in which the output of the driving source 78 is higher than that in the low-power range within its power range. In other words, a low-rotational-speed, low-power mode (LOW mode) and a high-rotational-speed, high-power mode (HI mode) are set as the two output modes of the driving source 78.

The valve unit 72 includes a plurality of control valves 73 (so-called solenoid valves) that individually switch extension and retraction of the plurality of hydraulic cylinders 302, 313, 314, 315, and 317. In the present example embodiment, the plurality of control valves 73 are provided in accordance with the number of the hydraulic cylinders 302, 313, 314, 315, and 317. In other words, the plurality of control valves 73 are provided so as to correspond to the boom cylinder 313, the arm cylinder 314, the bucket cylinder 315, and the swing cylinder 317, respectively.

Thus, the valve unit 72 includes at least four control valves 73 and 73 that correspond to the boom cylinder 313, the arm cylinder 314, the bucket cylinder 315, and the swing cylinder 317, respectively. In other words, the plurality of control valves 73 of the valve unit 72 include the arm control valve 73 including solenoids 732 and 732 that are capable of switching the supply and discharge of the hydraulic fluid to and from the arm cylinder 314 and that adjust the flow rate of the hydraulic fluid based on the value of a current input thereto and the boom control valve 73 including solenoids 732 and 732 that are capable of switching the supply and discharge of the hydraulic fluid to and from the boom cylinder 313 and that adjust the flow rate of the hydraulic fluid based on the value of a current input thereto. In the present example embodiment, the plurality of control valves 73 also include the bucket control valve 73 including solenoid 732 and 732 that are capable of switching the supply and discharge of the hydraulic fluid to and from the bucket cylinder 315 and that adjust the flow rate of the hydraulic fluid based on the value of a current input thereto. The plurality of control valves 73 and 73 further include control valves for the hydraulic actuators such as the swing cylinder 317, the swivel motor 210, and the traveling motor 50. Thus, the valve unit 72 (the control valves 73) of the present example embodiment not only controls the supply of the hydraulic fluid to the hydraulic cylinders 302, 313, 314, 315, and 317 but also controls the supply of the hydraulic fluid to the hydraulic motors 210 and 50.

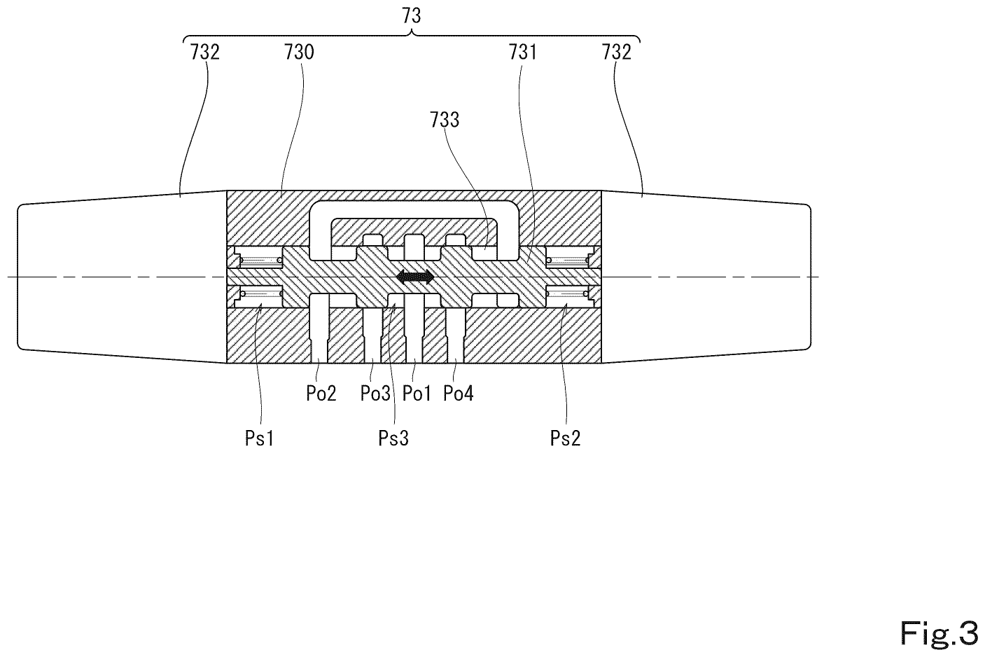

Each of the plurality of control valves 73 is an electromagnetic proportional directional flow control valve that is capable of switching a flow direction (flow path) of the hydraulic fluid and adjusting the flow rate of the hydraulic fluid to be circulated. As illustrated in FIG. 3, each of the plurality of control valves 73 includes a valve main body 730, a spool 731 that is movable in a predetermined axial direction in the valve main body 730 and that switches the flow path (flow direction) of the hydraulic fluid by its movement in the axial direction, and the solenoids 732 and 732 that cause the spool 731 to move in the axial direction.

The actuators 302, 313, 314, 315, 317, 210, and 50 operate in different manners, and thus, the manner in which the plurality of control valves 73 cause the hydraulic fluid to flow differs. Thus, the plurality of control valves 73 are different from each other in terms of the configuration of the spool 731, the arrangement of inlet and outlet ports for the hydraulic fluid with respect to the valve main body 730, and the number of the inlet and outlet ports. Here, a common control valve 73 will be described as a representative example. In other words, although the control valves 73 include the three-port control valve 73 having three inlet and outlet ports for the hydraulic fluid, the four-port control valve 73 having four inlet and outlet ports for the hydraulic fluid, and a five-port control valve 73 having five inlet and outlet ports for the hydraulic fluid, a common four-port control valve 73 will be described as a representative example.

In the four-port control valve 73, the valve main body 730 has a first connection port Po1 to which the secondary supply pipe 75 is connected, a second connection port Po2 to which the drain pipe 76 is connected, a third connection port Po3 to which one connecting pipe 77 of one of the pairs of connecting pipes 77 is connected, and a fourth connection port Po4 to which the other connecting pipe 77 of the pair of connecting pipes 77 is connected. The valve main body 730 has a spool accommodation space 733 in which the spool 731 is accommodated so as to be movable in the axial direction, and the first connection port Po1, the second connection port Po2, the third connection port Po3, and the fourth connection port Po4 are each connected to the spool accommodation space 733.

As described above, the spool 731 is movable in the axial direction and is configured to be capable of changing its position to a first connection position Ps1 that is shifted to one side in the axial direction, a second connection position Ps2 that is shifted to the other side in the axial direction, and an intermediate position Ps3 that is between the first connection position Ps1 and the second connection position Ps2.

When the spool 731 is at the first connection position Ps1, the control valve 73 allows the first connection port Po1 and the third connection port Po3 to communicate with each other and allows the second connection port Po2 and the fourth connection port Po4 to communicate with each other. When the spool 731 is at the second connection position Ps2, the control valve 73 allows the first connection port Po1 and the fourth connection port Po4 to communicate with each other and allows the second connection port Po2 and the third connection port Po3 to communicate with each other. When the spool 731 is at the intermediate position Ps3, the control valve 73 blocks each of the first connection port Po1 and the second connection port Po2 from each of the third connection port Po3 and the fourth connection port Po4.

In the present example embodiment, since the electromagnetic proportional directional flow control valve 73 is used as the control valve 73, the first connection position Ps1 and the second connection position Ps2 each have a width (a range) in the directions in which the spool 731 moves, and the opening of a flow passage changes steplessly depending on the position of the spool 731.

More specifically, assuming that the spool 731 is at the first connection position Ps1, the opening of a flow passage allowing communication between the first connection port Po1 and the third connection port Po3 changes in response to a change in the position of the spool 731 within the first connection position Ps1. Assuming that the spool 731 is at the second connection position Ps2, the opening of a flow passage allowing communication between the first connection port Po1 and the fourth connection port Po4 changes in response to a change in the position of the spool 731 within the second connection position Ps2. Thus, the control valve 73 can also adjust the flow rate of the hydraulic fluid because the opening of the flow passage is changed as the flow path of the hydraulic fluid is changed.

In the present example embodiment, the control valve 73 includes the solenoids 732 and 732, and the spool 731 is moved by energizing the solenoids 732 and 732. The spool 731 changes its position between the first connection position Ps1, the second connection position Ps2, and an intermediate position Ps3. The solenoids 732 and 732 vary (change) an energization force to be applied to the spool 731 in accordance with the value of a current that is input thereto.

As a result, by changing the value of the current input to the solenoids 732 and 732 (the energization force applied to the spool 731) in a state where the spool 731 is within a range between the first connection position Ps1 and the second connection position Ps2, the position of the spool 731 is changed (moved) in accordance with the value of the current input to the solenoids 732 and 732 (the energization force applied to the spool 731). As a result, the hydraulic fluid is supplied to the actuators (hydraulic cylinders, hydraulic motors) 302, 313, 314, 315, 317, 210, and 50 at a flow rate corresponding to the signal (current value) input to the solenoids 732 and 732.

The input signal (current value) is a current value that corresponds to the manipulation amount of the manipulator 23 (e.g., a manipulation lever 230) or is a current value that corresponds directly or indirectly to a parameter input to the input device 6. For example, the parameter that is input to the input device 6 is an excavation depth (a digging depth) from a ground level of earth.

The working machine 1 of the present example embodiment has an automatic excavation mode in which the shovel 31 excavates earth based on an input received by the input device 6. In the automatic excavation mode, the working machine 1 according to the present example embodiment is configured to be capable of performing a depth limiting function that prevent the bucket 312 from digging deeper than a desired depth (hereinafter, referred to as a “target excavation depth). In other words, when performing the automatic excavation mode, if the input device 6 receives an input to perform the depth limiting function (for setting the depth limiting function), the working machine 1 of the present example embodiment is configured to perform the depth limiting function (a depth limiting process) that causes the bucket 312 to move in a direction (horizontal direction) perpendicular to the vertical direction while maintaining the edge portion 312a of the bucket 312 at a preset target excavation depth position (height level).

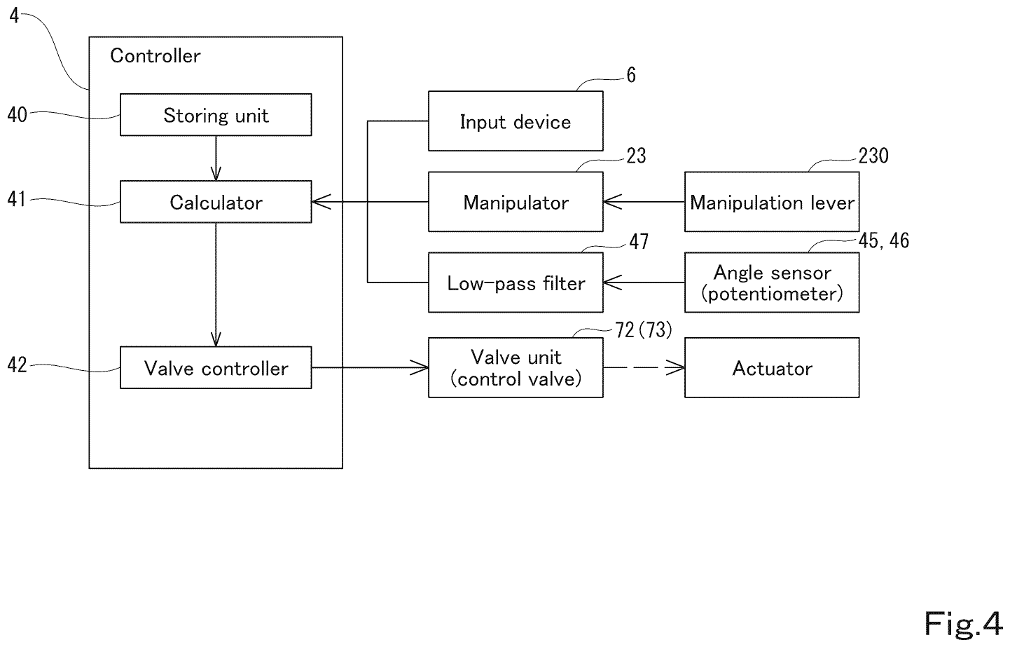

The automatic excavation mode (the depth limiting function) is performed by the controller 4. More specifically, as illustrated in FIG. 4, the controller 4 includes a storing unit (memory and/or storage) 40 that stores information, a calculator 41 that performs calculation based on the information stored in the storing unit 40 or information input to the input device 6, and a valve controller 42 configured or programmed to control the valve unit 72 and control the valve unit 72 (the solenoids 732 and 732) based on a result of the calculation performed by the calculator 41.

The valve controller 42 receives a result of the calculation from the calculator 41 and outputs a signal corresponding to the calculation result (the value of a current based on the calculation result) toward the solenoids 732 and 732 of the valve unit 72. As a result, the solenoids 732 and 732 of the valve unit 72 cause the spool 731 of the control valve 73 to move in the axial direction in accordance with the signal (the value of the current) from the valve controller 42, change the flow path or the flow rate of the hydraulic fluid, and cause the actuators 302, 313, 314, 315, 317, 210, and 50 to operate.

The controller 4 (the valve controller 42) is configured or programmed to control the valve unit 72, and, in the automatic excavation mode (the depth limiting process), in a state where the edge portion 312a of the bucket 312 has reached the set target excavation depth, the controller 4 (the valve controller 42) moves the bucket 312 in the direction perpendicular to the vertical direction while maintaining the height level of an end portion of the bucket 312. An excavation operation in which the edge portion 312a of the bucket 312 is caused to move in the direction perpendicular to the vertical direction is so-called horizontal dragging, and it is performed in a state where the posture (the angle) of the bucket 312 with respect to the arm 311 is kept constant or substantially constant. The horizontal dragging is typically performed in a state where the bucket 312 is in a fully dumped position (a maximum dump posture for discharging shoveled earth or the like) and where the relative positional relationship between the bucket 312 and the arm 311 is maintained. In other words, horizontal dragging is performed while keeping the bucket cylinder 315 in a fully contracted state.

Along with this, the controller 4 (the valve controller 42) swings (raises) the boom 310 while swinging the arm 311 such that the height (horizontal) level of the end portion of the bucket 312 remains constant or substantially constant while maintaining the relative positional (postural) relationship between the arm 311 and the bucket 312 constant.

When exhibiting the depth limiting function (when performing the depth limiting process), the controller 4 of the present example embodiment is configured or programmed to perform a former process and a latter process. The former process is performed when the working device 3 (the shovel 31) is activated from a non-operating state, and the latter process is performed in a state where a predetermined condition is satisfied after the working device 3 (the shovel 31) has started its operation.

In the former process of the depth limiting function, the controller 4 receives a desired target excavation depth of the excavation operation (horizontal dragging) performed by the bucket 312 and receives a signal to activate the arm 311, and in this state, the controller 4 derives a vertical distance from the current position (height) of the edge portion 312a to the target excavation depth as a movement amount of the edge portion 312a. Along with the derivation of the movement amount of the edge portion 312a, the controller 4 further derives the angle of rotation (rotational angle, a first rotational angle) of the arm 311 according to the movement amount (a rotational amount) of the arm 311, a target angular velocity at which the arm 311 is caused to rotate, a rotational angle (a second rotational angle) of the boom 310 according to the movement amount (a rotational amount) of the boom 310, and a target angular velocity at which the boom 310 is caused to rotate.

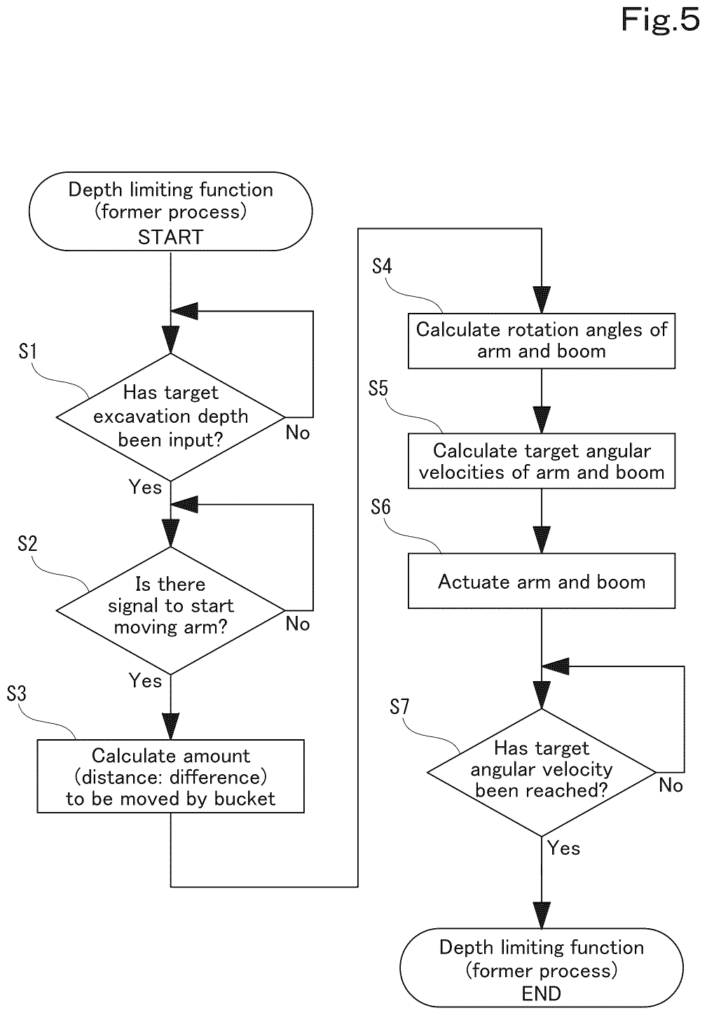

To be specific, when the controller 4 exhibits the depth limiting function (performs the depth limiting process), the controller 4 performs the former process. In the former process, as illustrated in FIG. 5, the controller 4 (the calculator 41) determines whether the target excavation depth is input to the input device 6 (S1) and waits for the input of the target excavation depth to the input device 6 (NO in S1). If the target excavation depth is input to the input device 6 (YES in S1), the controller 4 (the calculator 41) determines the presence or absence of a signal to activate the arm 311 (S2).

In the present example embodiment, when the manipulation lever 230 (see FIG. 1), which is included in the manipulator 23, is manipulated, the manipulator 23 transmits a signal to activate the arm 311 (starting the rotation of the arm 311) toward the controller 4. Thus, in the present example embodiment, the controller 4 (the calculator 41) determines whether the manipulation lever 230 is manipulated (S2) and waits until the manipulation lever 230 is manipulated (NO in S2). If the controller 4 (the calculator 41) determines that there is the signal to activate the arm 311 (YES in S2), the controller 4 derives the vertical distance from the current position (a height position) of the edge portion 312a of the bucket 312 to the target excavation depth position as the movement amount of the edge portion 312a of the bucket 312 (S3).

The movement amount of the edge portion 312a of the bucket 312 is the sum of the target excavation depth position (a digging depth from the ground level) input to the input device 6 by the operator and the vertical distance (the height from the ground level: coordinate values) from the position where the edge portion 312a of the bucket 312 is currently located to the ground level.

Although the target excavation depth position input to the input device 6 is known, the length from the position at which the edge portion 312a is located to the ground level is unknown. Thus, when deriving the movement amount of the edge portion 312a of the bucket 312, the controller 4 derives the length (coordinates in the vertical direction) from the edge portion 312a of the bucket 312 to the ground level. In the present example embodiment, the controller 4 derives the position (height) of the edge portion 312a of the bucket 312 based on the current postures (angles) of the arm 311 and the boom 310.

More specifically, the length of the boom 310 (the straight-line distance between the first lateral shaft S1 and the second lateral shaft S2) and the distance from the end portion of the arm 311 to the edge portion 312a of the bucket 312 (the straight-line distance between the second lateral shaft S2 and the edge portion 312a of the bucket 312) are constant on the assumption that the relative positional relationship between the bucket 312 and the arm 311 is constant (the bucket 312 is at a maximum dump position in the present example embodiment). Thus, the position (height) of the edge portion 312a of the bucket 312 can be derived from the angle of the boom 310 and the angle of the arm 311. In other words, by using a trigonometric function, the position (height) of the edge portion 312a of the bucket 312 can be calculated from the angle of the boom 310 and the angle of the arm 311.

As illustrated in FIG. 1, the working machine 1 includes a rotation sensor 46 that performs measurement relating to rotation of the arm 311 around the second lateral shaft S2. In the present example embodiment, the working machine 1 includes a boom angle detector 45 as a rotation sensor 45 that measures an angle (a rotational angle) of the boom 310 and an arm angle detector 46 that measures an angle (a rotational angle) of the arm 311. The working machine 1 of the present example embodiment further includes a bucket angle detector 48 that measures an angle (a rotational angle) of the bucket 312 around the third lateral shaft S3.

In the present example embodiment, a potentiometer is used as each of the angle detectors 45 and 46 (the boom angle detector 45 and the arm angle detector 46) which measure the angle of the boom 310 and the angle of the arm 311, respectively. The angle sensor (potentiometer) 45 that measures the angle of the boom 310 is attached to the first lateral shaft S1 and measures the angle of the boom 310 that rotates around the first lateral shaft S1. The angle sensor (potentiometer) 46 that measures the angle of the arm 311 is attached to the second lateral shaft S2 and measures the angle of the arm 311 that rotates around the second lateral shaft S2. In contrast, the bucket angle detector 48 measures the extension and retraction state of the bucket cylinder 315 (a piston position of a piston rod) and derives the posture of the bucket 312 (the rotational angle about the third lateral shaft S3) based on the measurement.

Thus, the height of the edge portion 312a of the bucket 312 can be calculated by using a trigonometric function based on the length of the boom 310 (the straight-line distance between the first lateral shaft S1 and the second lateral shaft S2), the distance from the end portion of the arm 311 to the edge portion 312a of the bucket 312 (the straight-line distance between the second lateral shaft S2 and the edge portion 312a of the bucket 312), and measurement results obtained by the angle sensors (potentiometers) 45 and 46 (the actual angles of the boom 310 and the arm 311).

Although the actual height of the edge portion 312a of the bucket 312 can be calculated in the manner described above, the controller 4 (the calculator 41) of the present example embodiment derives the height of the edge portion 312a of the bucket 312 based on the measurement results obtained by the angle sensors (potentiometers) 45 and 46 (the actual angles of the boom 310 and the arm 311) and the information stored in the storing unit 40 of the controller 4.

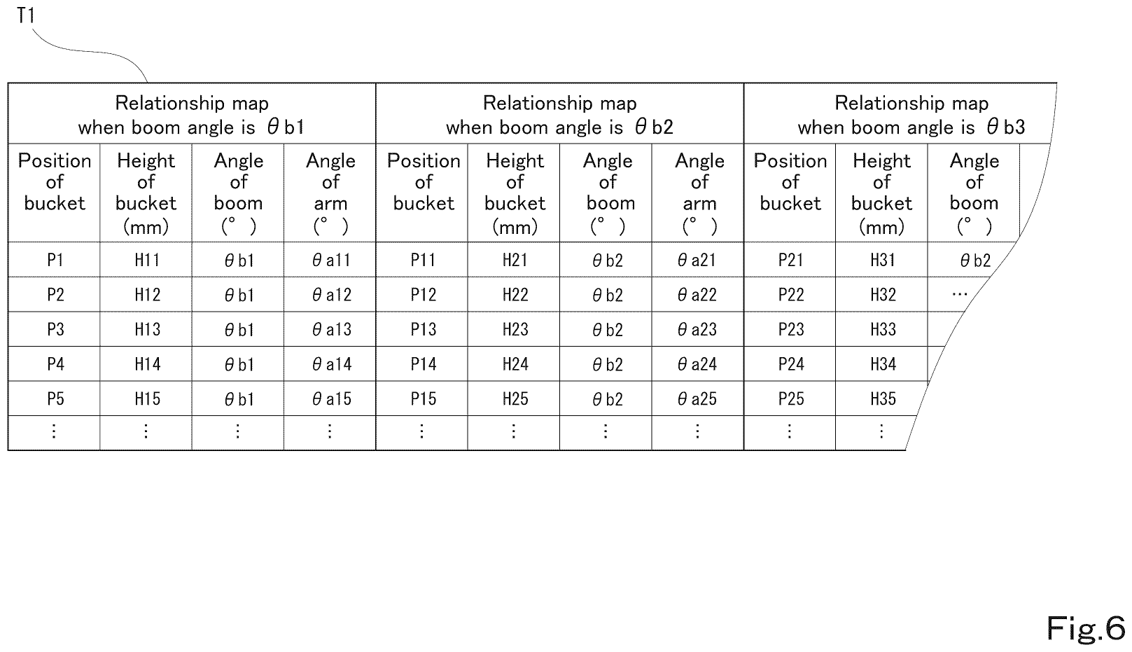

As illustrated in FIG. 6, the information stored in the storing unit 40 is a table (map) T1 that summarizes the relationship between angles θb1, θb2, etc., of the boom 310, angles θa11, θb12, etc., of the arm 311, and heights H11, H12, etc., of the edge portion 312a of the bucket 312 from the ground level.

The relationship between the angles θb1, θb2, etc., of the boom 310, the angles θa11, θb12, etc., of the arm 311, and the heights H11, H12, etc., of the edge portion 312a of the bucket 312 as presented in the table (map) T1 is based on the actual measurements taken from the operation of the working machine 1, taking into account the conditions of the actual working machine 1. In other words, the heights H11, H12, etc., of the edge portion 312a of the bucket 312 in the table (map) T1 are results of measurements performed for each posture (angle) of the arm 311 by changing the postures (angles) θa11, θb12, etc., of the arm 311 by a predetermined angle in each adjustment in a state where the postures (angles) θb1, θb2, etc., of the boom 310 are constant.

The controller 4 extracts the height of the edge portion 312a of the bucket 312 corresponding to a combination that is one of the combinations of the angles θb1, θb2, etc., of the boom 310 and the angles θa11, θb12, etc., of the arm 311 in the table (map) T1 and that matches a combination of the actual angles of the boom 310 and the arm 311, which is a measurement result obtained by the angle sensors (potentiometers) 45 and 46.

The controller 4 (the calculator 41) sums the extracted height of the edge portion 312a of the bucket 312 with the target excavation depth input to the input device 6 and calculates the movement amount (a moving distance) of the edge portion 312a of the bucket 312.

Returning to FIG. 5, after calculating the movement amount (moving distance) of the edge portion 312a of the bucket 312 (S3), the controller 4 (the calculator 41) sets the rotational angle of the arm 311, which corresponds to the movement amount (rotational amount) of the arm 311, and the target angular velocity at which the arm 311 is caused to rotate, and the controller 4 (the calculator 41) also sets the rotational angle of the boom 310, which corresponds to the movement amount (rotational amount) of the boom 310, and the target angular velocity at which the boom 310 is caused to rotate (S4, S5).

More specifically, the controller 4 (the calculator 41) is configured or programmed to extract, from the table T1 stored in the storing unit 40, a combination of the angle of the arm 311 and the angle of the boom 310 for causing the edge portion 312a of the bucket 312 to move in the direction perpendicular to the vertical direction (to perform the so-called horizontal dragging) while the edge portion 312a of the bucket 312 is at the target excavation depth. In other words, the calculator 41 also is configured or programmed to extract, from the table T1 stored in the storing unit 40, a plurality of combinations of the angle of the arm 311 and the angle of the boom 310 with which the edge portion 312a of the bucket 312 is at the target excavation depth.

Here, a combination in which the edge portion 312a of the bucket 312 is located at a position farthest from the machine body 2 in a state where it has reached the target excavation depth from the current position is extracted. In other words, among the plurality of combinations of the angle of the arm 311 and the angle of the boom 310 with which the edge portion 312a of the bucket 312 is at the target excavation depth, a combination in which the angle of the boom 310 is the smallest is extracted.

Then, in order to lower the edge portion 312a of the bucket 312 from the current position to the target excavation depth, the controller 4 (the calculator 41) is configured or programmed to calculate the rotational angle of the arm 311 by subtracting the angle of the arm 311 extracted from the table T1 from the current angle of the arm 311 and calculate the rotational angle of the boom 310 by subtracting the angle of the boom 310 extracted from the table T1 from the current angle of the boom 310 (S4).

As a result, the rotational amount (rotational angle) of the arm 311 and the rotational amount (rotational angle) of the boom 310 required for the edge portion 312a of the bucket 312 to reach the target excavation depth from the current position (to move downward to the target excavation depth) are derived.

In order to allow the edge portion 312a of the bucket 312 to perform “horizontal dragging” (to horizontally move at a constant height), the controller 4 (the calculator 41) is configured or programmed to calculate the rotational angle of the boom 310 to perform horizontal dragging by subtracting the angle of the boom 310 that is extracted from the table T1 and that is combined with the largest angle of the arm 311 from the angle of the boom 310 in a state where the edge portion 312a of the bucket 312 has reached the target excavation depth from the current position (S4). The calculator 41 is configured or programmed to calculate the rotational angle of the arm 311 to perform the horizontal dragging by subtracting the angle of the arm 311 that is extracted from the table T1 and that is combined with the largest angle of the boom 310 from the angle of the arm 311 in a state where the edge portion 312a of the bucket 312 has reached the target excavation depth from the current position (S4).

Then, when performing a first process (hereinafter referred to as a “horizontal dragging process”) in which the arm 311 is caused to rotate around the second lateral shaft S2 in a direction toward the boom 310 (one side of a circumferential direction) while the boom 310 is caused to rotate around the first lateral shaft S1 and raised so as to perform excavation along the target excavation depth, the controller 4 (the calculator 41) is configured or programmed to set a first target angular velocity and a second target angular velocity in accordance with the distance from the edge portion 312a in a movement start position to the target excavation depth, the first target angular velocity being a target angular velocity corresponding to the period of time elapsed from the start of movement of the arm 311, and the second target angular velocity being a target angular velocity corresponding to the period of time elapsed from the start of movement of the boom 310. In the present example embodiment, as described above, the controller 4 (the calculator 41) is configured or programmed to calculate the rotational angle of the boom 310 and the rotational angle of the arm 311 in order to calculate the rotational angle of the boom 310 and the rotational angle of the arm 311 (S4) and then derives the first target angular velocity of the arm 311 when the arm 311 rotates about the second lateral shaft S2 by the calculated rotational angle and the second target angular velocity of the boom 310 when the boom 310 rotates around the first lateral shaft S1 by the calculated rotational angle (S5).

In the present example embodiment, the first target angular velocity is set by the controller 4 (the calculator 41) such that, as the distance from the movement start position (an activation position) of the edge portion 312a of the bucket 312 to the target excavation depth becomes shorter (as the amount to be moved by the edge portion 312a of the bucket 312 in the vertical direction becomes smaller), an initial angular velocity at the time of the start of movement decreases and the angular acceleration (slope of angular velocity) during a predetermined first period of time elapsed from the start of movement increases. Accordingly, in the present example embodiment, the first target angular velocity is set by the controller 4 (the calculator 41) such that, as the distance from the movement start position (activation position) of the edge portion 312a of the bucket 312 to the target excavation depth becomes longer (as the movement amount of the edge portion 312a of the bucket 312 in the vertical direction becomes greater), the initial angular velocity at the time of the start of movement increases and the angular acceleration (slope of angular velocity) during the first period of time elapsed from the start of movement decreases. In other words, the initial angular velocity is set by the controller 4 (the calculator 41) such that, as the amount to be moved by the edge portion 312a of the bucket 312 becomes closer to the lower limit of an allowable range of movement, the initial angular velocity at the time of the start of movement decreases and the angular acceleration (slope of angular velocity) during a predetermined period of time elapsed from the start of movement increases, and on the other hand, the initial angular velocity is set by the controller 4 (the calculator 41) such that, as the amount to be moved by the edge portion 312a of the bucket 312 becomes farther from the lower limit of the allowable range of movement, the initial angular velocity at the time of the start of movement increases and the angular acceleration (slope of angular velocity) during a predetermined period of time elapsed from the start of movement decreases. The first target angular velocity is set such that it increases from the start of movement of the boom 310 until the first period of time elapses and such that, after the first period of time has elapsed, it becomes constant at a predetermined maximum value.

In contrast, the second target angular velocity is set in accordance with the first target angular velocity. Consequently, the second target angular velocity is set such that it increases from the start of movement of the arm 311 until a predetermined second period of time passes and becomes constant at a predetermined maximum value after the second period of time has passed. Here, the predetermined first period of time is a period of time during which the first target angular velocity reaches its maximum value, and the predetermined second period of time is a period of time during which the second target angular velocity reaches its maximum value. In the present example embodiment, the first period of time is set to be equal to or shorter than the second period of time. Accordingly, the timing at which the arm 311 reaches a constant speed is the same as or later than the timing at which the boom 310 reaches a constant speed. Although the movement allowance of the edge portion 312a of the bucket 312 can be arbitrarily set, when the movement allowance is at its maximum, the lower limit is set to 0 (zero), which includes a situation where the edge portion 312a of the bucket 312 does not move in the vertical direction. The upper limit of the movement allowance is set to the height of the highest position of the edge portion 312a of the bucket 312 in a state where the boom 310 and the arm 311 are raised to their maximum.

As illustrated in FIG. 6, a plurality of positions P1, P2, etc., of the edge portion 312a in the vertical direction are set by combinations of the plurality of heights H11, H12, etc., a plurality of angles of the arm 311, and a plurality of angles of the boom 310. In order to match this, in the present example embodiment, the angular velocity of the arm 311 is set for each of the plurality of positions P1, P2, etc., of the edge portion 312a in the vertical direction within the allowable range of movement.

In the controller 4 of the present example embodiment, the first target angular velocity is derived from Equations (1) to (3) below. More specifically, the controller 4 sets the initial angular velocity of the arm 311 using Equation (1) below, sets the rate of increase of the angular velocity of the arm 311 during the predetermined first period of time elapsed from the start of movement using Equation (2) below, and sets the first target angular velocity during the predetermined first period of time elapsed from the start of movement using Equation (3) below.

Initial angular velocity ωs=(P×k)−Nd Equation (1)

Rate of increase α of angular velocity=(ωmax−ωs)/Ta Equation (2)

First target acceleration=α×Tb+ωs Equation (3)
where P represents the distance between the edge portion and the target excavation depth at the time of the start of movement,
k represents a preset coefficient,
Nd represents the difference of the output of the driving source from an output in the high-power mode,
ωmax represents an estimated maximum angular velocity of the arm corresponding to the output of the driving source,
Ta represents the time taken to reach the maximum angular velocity, and
Tb represents the period of time from activation (first period of time).

When Equation (3), which has been mentioned above, is represented as a graph, α×Tb denotes the slope of the graph, with the horizontal axis and the vertical axis representing period of time and the target angular velocity, respectively, while ωs denotes the intercept of the same graph. In other words, α×Tb+ωs is an expression representing the angular acceleration of the arm 311 during the first period of time, during which the arm 311 is accelerated, and ωs, that is, Expression (1) is an expression representing the initial angular velocity of the arm 311. As a result, when the arm 311 that has no actual angular velocity due to inactivity is activated, the arm 311 operates at a speed at which the bucket 312 does not excessively dig deeper than the target position and at which the operator does not feel strange with the movement of the arm 311. In particular, in Equation (1) that determines the initial angular velocity, the coefficient k based on an actual measurement and the difference Nd corresponding to the rotational speed of the driving source 78 are taken into account, and thus, the initial angular velocity reaches an ideal value, which is an appropriate value that corresponds to the operational state of the working machine 1 (the driving source 78).

The initial angular velocity ωs in Equation (1) and the estimated maximum angular velocity ωmax in Equation (2) are each obtained by dividing the rotational angle of the arm 311 by time. The coefficient k is a reflection coefficient to adjust the first target angular velocity, which is derived, to an appropriate value. In the present example embodiment, the coefficient k is set (tuned) so as to approach an ideal result based on actual measurements taken from the actual machine.

In the present example embodiment, as described above, the output mode of the driving source 78 can be switched between the two power modes, which are the low-rotational-speed, low-power mode (LOW mode) and the high-rotational-speed, high-power mode (HI mode), and thus, in Equation (1), which has been mentioned above, the difference Nd corresponding to the rotational speed of the driving source 78 is taken into account. The difference Nd is set to be higher when the rotational speed of the driving source 78 is low than when the rotational speed of the driving source 78 is high. The difference Nd between the rotational speed at the low output and the rotational speed at the high output is obtained by linear interpolation based on the value in the low-power mode and the value in the high-power mode.

Here, ωmax (estimated maximum angular velocity of the arm 311), ωs (estimated initial velocity of the arm 311), Ta (estimated time taken to reach the maximum angular velocity), Tb (assumed first period of time), P (starting position), k (coefficient), and (difference corresponding to engine rotational speed) are all assumed values, and ideal values obtained from operational verification of the actual machine are used for each position (starting position) of the edge portion 312a of the bucket 312.

The estimated maximum angular velocity ωmax of arm 311 varies depending on the output of the driving source 78. In the present example embodiment, the high-rotational-speed, high-power mode (the case of high-rotational-speed and high-output) and the low-rotational-speed, low-power mode (the case of low-rotational-speed and low-output) are set as the output modes of the driving source 78.

Accordingly, in the present example embodiment, ωmax (estimated maximum angular velocity of the arm 311) is set to 5500 in the case of the high-rotational-speed, high-power mode (HI mode) and is set to 7000 in the case of the low-rotational-speed, low-power mode (LOW mode). The time Ta taken to reach the maximum angular velocity is uniformly set to 1000 msec, and the difference Nd corresponding to the rotational speed of the driving source 78 is based on the low-rotational-speed, low-power mode (LOW mode). In the case of the high-rotational-speed, high-power mode (HI mode), the difference Nd is 1500, which is the difference between 5500 in the high-rotational-speed, high-power mode and 7000 in the low-rotational-speed, low-power mode. In the case of the low-power mode, the difference is set to 0 (zero) as it is based on the low-power mode. The coefficient k is set to 15. In the case where the coefficient k is set to be greater than 15, the initial velocity increases. In the case where the coefficient k is set to be less than 15, the initial velocity decreases.

Thus, in the present example embodiment, the above values are substituted into Equation (4) that will be mentioned below and that is obtained by combining Equation (1) to Equation (3). The first target angular velocity in the high-rotational-speed, high-power mode is calculated (derived) from Equation (5) that is an equation for the case where the driving source 78 is in the high-rotational-speed, high-power mode, and the first target angular velocity in the low-rotational-speed, low-power mode is calculated (derived) from Equation (6) that is an equation for the case where the driving source 78 is in the low-rotational-speed, low-power mode.

First target angular acceleration=(ωmax−((P×k)−Nd))/Ta)×Tb+((P×k)−Nd) Equation (4)

First target angular velocity in high-rotational-speed, high-power mode=(ωmax−((P×15)−1500))/1000×Tb+((P×k)−1500) Equation (5)

First target angular velocity in low-rotational-speed, low-power mode=(ωmax−((P×15)−0))/1000×Tb+((P×15)−0) Equation (6)

In contrast, the second target angular velocity is set so as to correspond to a first target rotational angle as mentioned above. More specifically, the second target angular velocity is derived by multiplying the first target angular velocity by a predetermined reflection coefficient that causes the second target angular velocity to be lower than the first target angular velocity. In the storing unit 40, the second target angular velocity that is to be combined with the first target angular velocity, is also stored as a table (a map) together with the first target angular velocity.

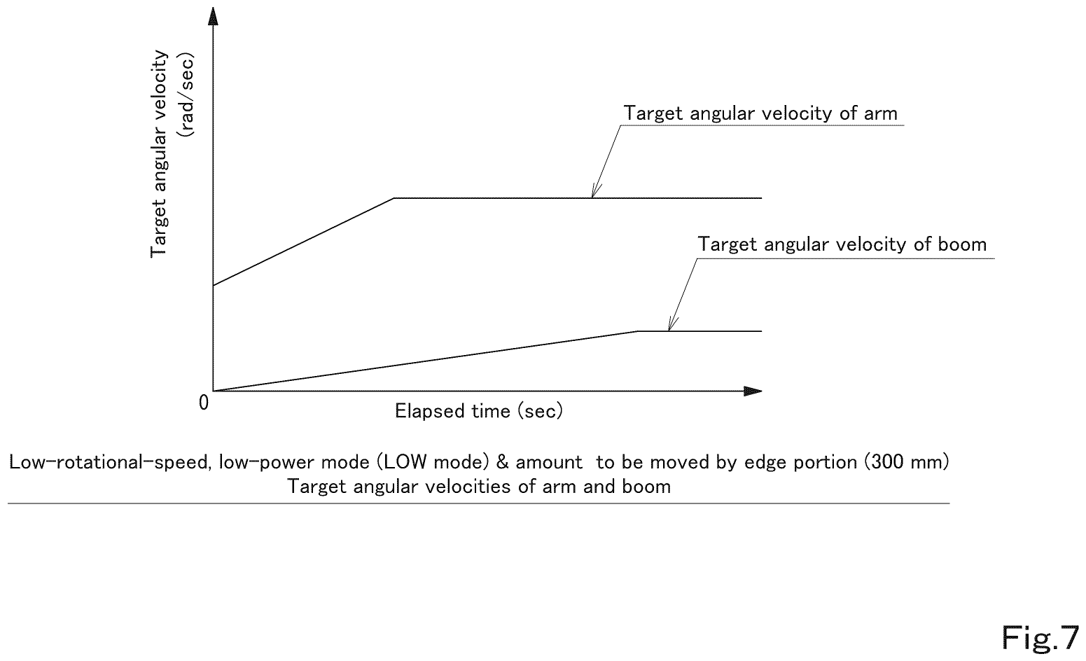

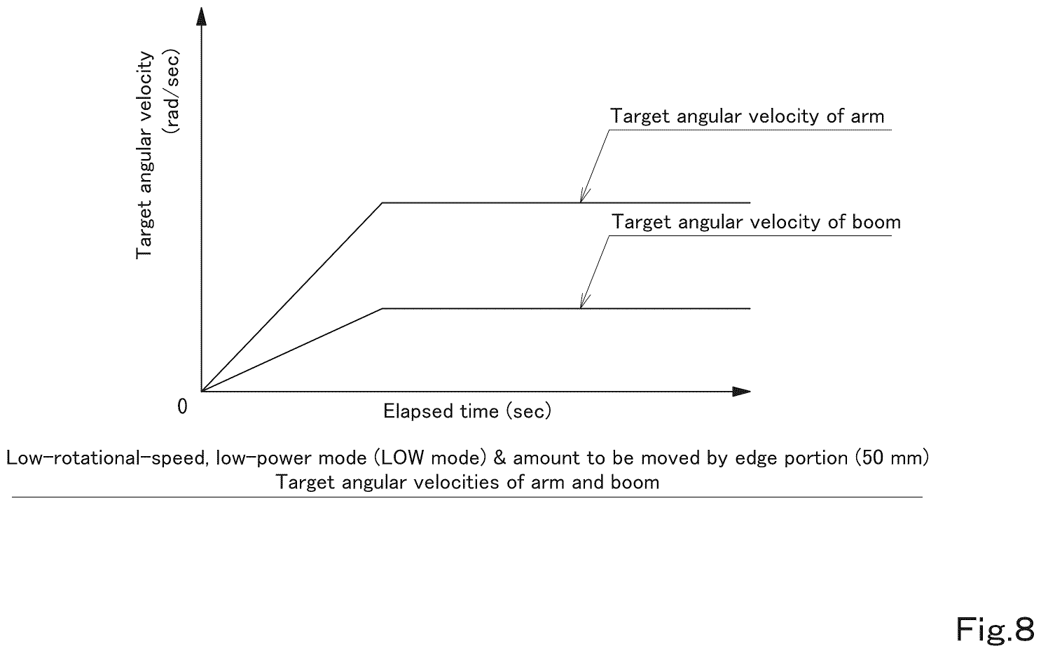

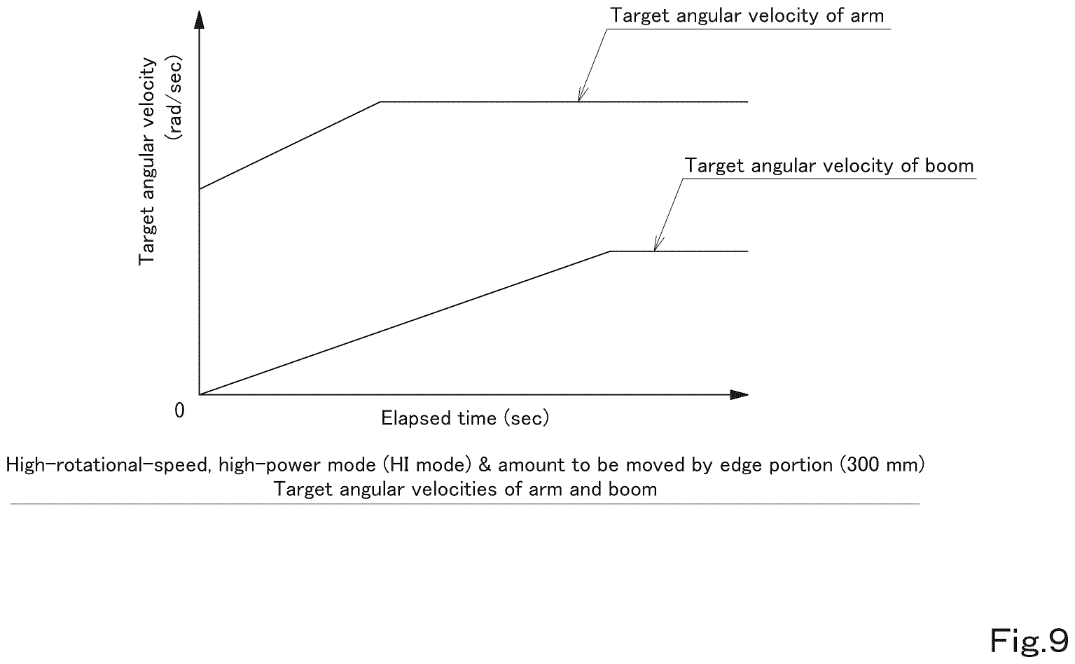

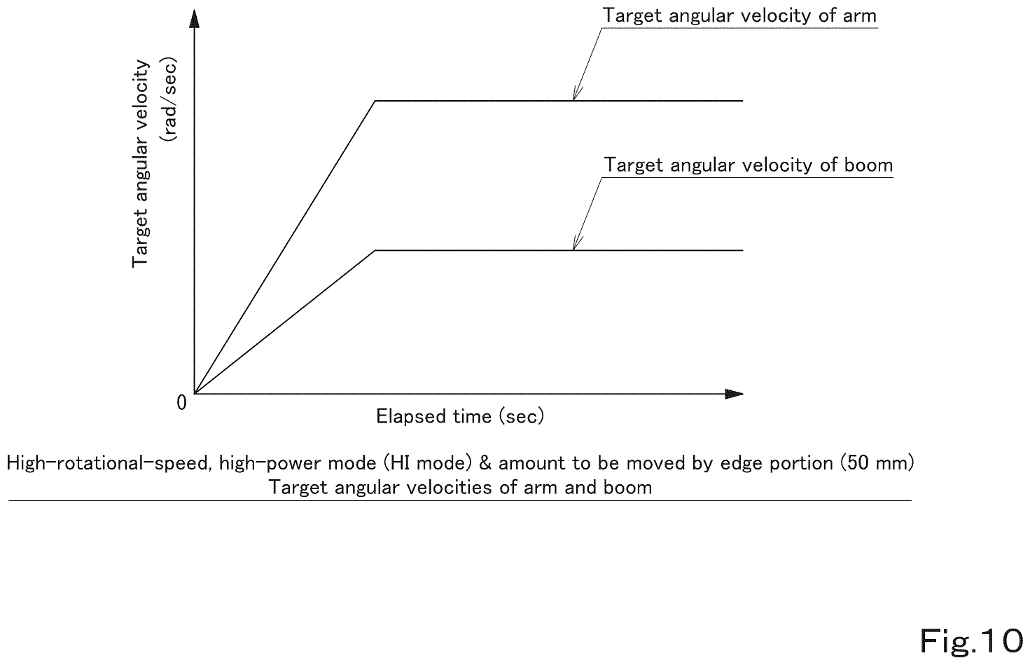

Regarding the case where the movement amount of the edge portion 312a of the bucket 312 is large (e.g., 300 mm) and the case where the movement amount of the edge portion 312a of the bucket 312 is small (e.g., 50 mm), the relationship between the first target angular velocity that is obtained by using Equation (5) and Equation (6), the second target angular velocity that is derived based on the first target angular velocity, and the period of time is represented by graphs as illustrated in FIG. 7 to FIG. 10. As is clear from the graphs illustrated in FIG. 7 to FIG. 10, regardless of the rotational speed of the driving source 78, when the movement amount of the edge portion 312a of the bucket 312 is small, the initial velocity of the arm 311 is likely to be low, and the angular acceleration of the arm 311 until the first period of time passes is likely to be large. When the movement amount of the edge portion 312a of the bucket 312 is large, the initial velocity of the arm 311 is likely to be high, and the angular acceleration of the arm 311 until the first period of time passes is likely to be small. When the output of the driving source 78 is high, the first target angular velocity is likely to be lower than that when the output of the driving source 78 is low.

As described above, when the controller 4 (the calculator 41) derives the first target angular velocity and the second target angular velocity each corresponding to the movement amount of the edge portion 312a of the bucket 312, since the controller 4 (the calculator 41) has received a signal to activate the arm 311, as illustrated in FIG. 5, the controller 4 (the calculator 41) causes the arm 311 to rotate (causes the arm 311 to operate) around the second lateral shaft S2 in such a manner as to correspond to the derived result and causes the boom 310 to rotate (causes the boom 310 to operate) around the first lateral shaft S1 in such a manner as to correspond to the derived result (S6). In other words, the calculator 41 converts the first target angular velocity into a corresponding value of the current while converting the second target angular velocity into a corresponding value of the current and instructs the valve controller 42 to send signals (the current corresponding to the current values obtained by converting the target angular velocities) to the solenoids 732 and 732 of the control valve 73 such that the arm 311 rotates at the derived first target angular velocity or an approximation of the first target angular velocity for a predetermined period and such that the boom 310 rotates as the derived second target angular velocity or an approximation of the second target angular velocity for a predetermined period.

Along with this, the valve controller 42 sends an input current to the solenoids 732 and 732 of the control valve 73 such that the arm 311 rotates at the first target angular velocity (such that the hydraulic fluid is supplied to the arm cylinder 314 at an appropriate flow rate) and sends an input current to the solenoids 732 and 732 of the control valve 73 such that the boom 310 rotates at the second target angular velocity (such that the hydraulic fluid is supplied to the boom cylinder 313 at an appropriate flow rate). As a result, the arm 311 and the boom 310 respectively rotate at the first and second target angular velocities (angular accelerations) corresponding to the movement amount of the edge portion 312a of the bucket 312.

As described above, since the initial velocity is low when the movement amount of the edge portion 312a of the bucket 312 is small, the arm 311 and the boom 310 operate without sudden activation. As a result, even in the case where the edge portion 312a of the bucket 312 is near the ground level and its movement amount is small, the rotational movement of the arm 311 does not affect the bucket 312, and the bucket 312 is prevented from digging earth deeper than the target excavation depth of earth. Since the second target angular velocity is determined based on the first target angular velocity, the boom 310 operates in accordance with the operation of the arm 311. As a result, the effect of the operation of the boom 310 on the motion (movement) of the bucket 312 is minimal, and excavation is appropriately performed by the bucket 312.

When the arm 311 and the boom 310 each continue to accelerate at an angular acceleration based on (corresponding to) the corresponding target angular velocity, the actual angular velocities (the angular velocities actually measured by the potentiometers 45 and 46) of the arm 311 and the boom 310 reach the respective target rotational angles. In the present example embodiment, when the arm 311 and the boom 310 reach their maximum target angular velocities, the arm 311 and the boom 310 rotate at a constant speed while maintaining their maximum target angular velocities until their rotational angles reach their respective derived rotational angles.

When the actual angular velocities of the arm 311 and the boom 310 (the actual angular velocities based on the detection performed by the potentiometers 45 and 46) reach their respective maximum target rotational angles (YES in S7), the controller 4 (the calculator 41) terminates the former process (END) and switches from the former process to the latter process so as to control the arm 311 and the boom 310.

When the actual angular velocity of the arm 311 reaches the first target angular velocity (the maximum target angular velocity) and the actual angular velocity of the boom 310 reaches the second target angular velocity (the maximum target angular velocity) derived based on the first target angular velocity, the controller 4 (the calculator 41) switches from the former process to the latter process. As described above, in the present example embodiment, when the actual angular velocities of the arm 311 and the boom 310 reach (have reached) their respective maximum target angular velocities, the arm 311 and the boom 310 rotate at a constant speed while maintaining their maximum target angular velocities until their rotational angles reach their respective derived rotational angles, and thus, when the actual angular velocity of at least one of the arm 311 and the boom 310 (both of them in the present example embodiment) reaches the maximum target angular velocity, the process is switched from the former process to control the arm 311 and boom 310 that are in an acceleration state to the latter process to control the arm 311 and boom 310 that are in a constant speed state.

More specifically, as described above, the working machine 1 includes potentiometers as the angle detectors 45 and 46 (the boom angle detector 45 and the arm angle detector 46). The potentiometers 45 coupled to the first lateral shaft S1 measures the rotational amount (the angle) of the boom 310 around the first lateral shaft S1, and the potentiometer 46 coupled to the second lateral shaft S2 measures the rotational amount (the angle) of the arm 311 around the second lateral shaft S2. Thus, the actual angular velocities of the arm 311 and the boom 310 can be measured from the relationship between the actually measured rotational angles of the arm 311 and the boom 310 and the periods of time during which the arm 311 and the boom 310 actually rotate.

Along with the above, the controller 4 (the calculator 41) instructs the valve controller 42 of the hydraulic system 7 to bring the angular velocities of the arm 311 and the boom 310 close to their respective target angular velocities (their respective maximum target angular velocities).

As described above, the working machine 1 detects the angles of the arm 311 and the boom 310 by using the potentiometers 45 and 46. However, the outputs of the potentiometers 45 and 46 fluctuate. Accordingly, as illustrated in FIG. 4, the working machine 1 includes a low-pass filter 47 that removes (blocks) noise included in the outputs of the potentiometers 45 and 46. In the present example embodiment, a 5×5 Gaussian filter is used as the low-pass filter 47, and it removes noise that hinders the control performed by the controller 4, increasing the accuracy of detection results (detected angles) obtained by the potentiometers 45 and 46.

In the latter process, the controller 4 (the calculator 41) is configured or programmed to perform control to reduce or prevent hunting of the edge portion 312a of the bucket 312 that occurs when the bucket 312 moves in the direction perpendicular to the vertical direction (when the edge portion 312a of the bucket 312 is caused to move at a constant depth (height position)). In other words, the controller 4 is configured or programmed to control rotation of at least one of the boom 310, the arm 311, and the bucket 312 based on an output value obtained by applying a correction function based on the actual angular velocity directly or indirectly to the difference (error value) between a target angular velocity when at least one of the boom 310, the arm 311, and the bucket 312, which are the subjects of rotation measurements performed by the angle detectors 45, 46, and 48, rotates and the actual angular velocity of at least one of the boom 310, the arm 311, and the bucket 312 derived from the measurement results obtained by the angle detectors 45, 46, and 48.

As described above, the boom 310, the arm 311, and the bucket 312 are the to-be-measured objects of the angle detector 45, 46, and 48. However, in the present example embodiment, the controller 4 is configured or programmed to limit a control target to reduce or prevent hunting to only the boom 310.

More specifically, in the latter process in the present example embodiment, the controller 4 applies, to the rotation of the boom 310, an output value obtained by directly or indirectly applying the correction function based on the actual angular velocity to the difference (error value) e between a predetermined target angular velocity (in the present example embodiment, the second target angular velocity derived from the former process), which is ideal when the boom 310 rotates around the first lateral shaft S1, and the actual angular velocity.

In the present example embodiment, the correction function includes a proportional component and a derivative component obtained by decomposing the actual angular velocity. In the present example embodiment, the controller 4 is configured or programmed to decompose the difference e into a proportional component and an integral component and applies the proportional component and the derivative component of the actual angular velocity to the proportional component and the integral component of the difference e to obtain an output value.

In other words, the controller 4 is configured or programmed to perform PI-PD control (proportional-derivative lead PI Control) or PID-P control (proportional lead PID control) based on the target angular velocity that is derived beforehand and an angular velocity (actual angular velocity) actually measured by the boom angle detector (a rotation sensor: an angle sensor) 45. In the present example embodiment, the controller 4 performs PI-PD control.

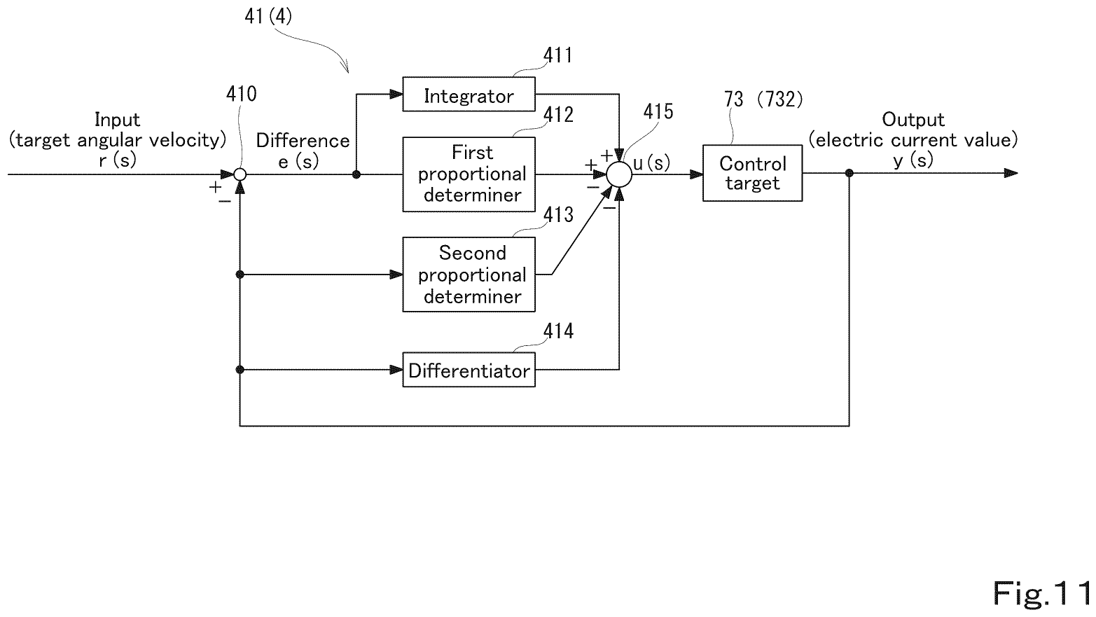

As illustrated in FIG. 11, the controller 4 that performs proportional-derivative lead PI-PD control is configured or programmed to include a subtractor 410, an integrator 411, proportional determiners 412 and 413, a differentiator 414, and an adder-subtractor 415. In the present example embodiment, in order to perform the PI-PD control, the controller 4 includes the two proportional determiners 412 and 413.

More specifically, the controller 4 (the calculator 41) is configured or programmed to include the subtractor 410 that outputs the difference between a target angular velocity (the second target angular velocity) and an actual angular velocity, the integrator 411 that determines an integral component of the difference output by the subtractor 410, the first proportional determiner 412 that determines a proportional component of the difference output by the subtractor 410, the second proportional determiner 413 that determines a proportional component of the actual angular velocity, the differentiator 414 that determines a derivative component of the actual angular velocity, and the adder-subtractor 415 that performs addition and subtraction of the outputs of the integrator 411, the first proportional determiner 412, the second proportional determiner 413, and the differentiator 414. The controller 4 (the calculator 41) is configured or programmed to output the output value obtained by the adder-subtractor 415 as a signal for the control valve 73.

When a target angular velocity, which is a target value, is input, the subtractor 410 of the controller 4 (the calculator 41) is configured or programmed to calculate, as the difference e, the difference between the input target angular velocity and an angular velocity that is actually measured (an actual angular velocity). The difference e calculated by the subtractor 410 is input to the first proportional determiner 412 and the integrator 411. A measurement result obtained by the boom angle detector 45 (the actual angular velocity of the boom 310), which is an output, is input to the subtractor 410 and is also input to the second proportional determiner 413 and the differentiator 414 in order to calculate the difference e between the target angular velocity and the actual angular velocity. The output results of the first proportional determiner 412, the integrator 411, the second proportional determiner 413, and the differentiator 414 are combined (added and subtracted) by the adder-subtractor 415, and the result is output as a necessary correction amount (a correction amount to be applied to the actual angular velocity). More specifically, the output of the integrator 411 is added to the output of the first proportional determiner 412, and the output of the second proportional determiner 413 and the output of the differentiator 414 are subtracted therefrom, so that a necessary correction amount is output u.

In the adder-subtractor 415, the output of the integrator 411 is added to the output of the first proportional determiner 412, and the output results of the second proportional determiner 413 and the differentiator 414 are subtracted from this result, so that a necessary correction amount is output. Along with this, the controller 4 instructs the valve controller 42 to adjust the flow rate of the hydraulic fluid supplied to the boom cylinder 313 such that the correction amount is applied to the angular velocity (the angular velocity is corrected), and the valve controller 42 outputs, in accordance with the instruction from the controller 4, a current (a signal) having a current value corresponding to the flow rate of hydraulic fluid at which the angular velocity of the boom 310 becomes the corrected angular velocity, to the solenoids 732 and 732 of the valve unit 72 (the control valve 73).

In this manner, the P (proportional) component and the D (derivative) component of the actual angular velocity obtained by the outputs of the potentiometers 45 and 46 are fed back to the adder-subtractor 415 by the second proportional determiner 413 and the differentiator 414 and applied to the output results of the first proportional determiner 412 and the integrator 411, which are based on the difference e. Thus, the boom 310 rotates in a state where the fluctuations of the actual angular velocity (deviation from the target angular velocity) that causes hunting (vertical oscillation) of the foremost bucket 312 coupled to the end portion of the arm 311 has been corrected.

More specifically, in the PI-PD control of the present example embodiment, the P (proportional) component and the D (derivative) component of the actual angular velocity are information regarding an intended operating amount to be changed (a difference in the output that should be) based on the current actual angular velocity and the previous actual angular velocity, and thus, the output of the difference e applied to the P (proportional) component and the I (integral) component by the adder-subtractor 415 becomes an optimal value by correcting the output based on the difference e (the output of the difference e based on the P (proportional) component and the D (derivative) component) with high accuracy. The processing for deriving the D (derivative) component is performed in an extremely short time compared to the processing for deriving the I (integral) component, resulting in superior responsiveness when the D (derivative) component is applied to the output.

Thus, by driving the solenoids 732 and 732 of the control valve 73 that controls driving of the boom 310, which is to be controlled by this output (the value of the current corresponding to the angular velocity), the deviation (fluctuations) between the actual angular velocity of the boom 310 and the target angular velocity can be reduced or prevented, and the occurrence of hunting of the bucket 312, which is coupled to the end of the arm 311, can be reduced or prevented. As described above, the working machine 1 according to the present example embodiment includes the low-pass filter 47 (5×5 Gaussian filter), and thus, the accuracy of the detection results (detected angles) obtained by the potentiometers 45 and 46 is increased. Thus, the control using the detection results obtained by the potentiometers 45 and 46, that is, an effect obtained from the former process, and an effect obtained from the PI-PD control in the latter process become more favorable.

In the present example embodiment, the target of control to prevent hunting of the bucket 312 is limited to the boom 310. However, as mentioned above, either the arm 311 or the bucket 312 may be the target of the control instead of the boom 310. Alternatively, at least two of the boom 310, the arm 311, and the bucket 312 may be the targets of the control to prevent hunting of the bucket 312. When the arm 311 and the bucket 312 are to be controlled, as in the case where the boom 310 is controlled, the arm 311 may be controlled based on the detection result obtained by the arm angle detector 46, and the bucket 312 may be controlled based on the detection result obtained by the bucket angle detector 48. The above description of the control to prevent hunting of the bucket 312 becomes an explanation of the control of the arm 311 or the control of bucket 312 by substituting the boom 310 with the arm 311 or the bucket 312 and substituting the boom angle detector 45 with the arm angle detector 46 or the bucket angle detector 48.

In the manner described above, the latter process is performed, and the arm 311 and the boom 310 are caused to rotate to their respective derived rotational angles in a state where the bucket 312 is horizontally pulled. After that, the arm 311 and the boom 310 stop rotating, and the horizontal dragging performed by the bucket 312 is completed. In the present example embodiment, when the operator manipulates the manipulation lever 230 at the time of the completion of the horizontal dragging of the bucket 312, the bucket 312 can shovel or dump earth.

In the automatic excavation mode of the working machine 1 of the present example embodiment, the horizontal dragging is performed in a state where the bucket 312 is positioned at a dump end, and thus, if the bucket 312 performs a shoveling operation (the bucket 312 rotates around the third lateral shaft S3) in a state where the horizontal dragging is completed, the edge portion 312a of the bucket 312 will follow a path on an imaginary circle VC that is centered on the third lateral shaft S3, and the edge portion 312a of the bucket 312 will pass below the target excavation depth.

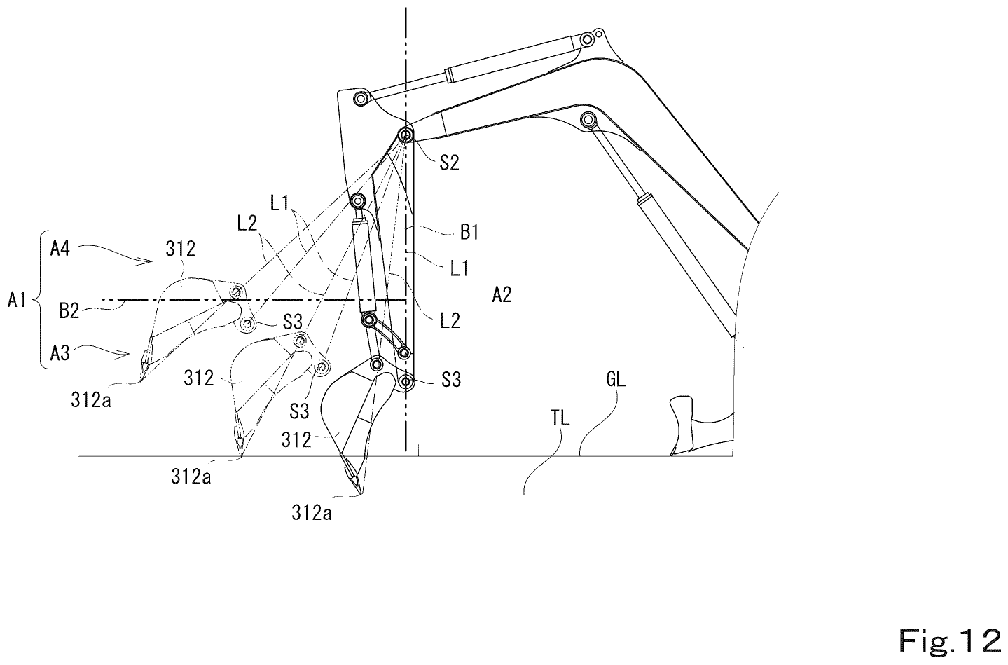

In order to prevent such a situation from occurring, the working machine 1 of the present example embodiment has an output limiting function of limiting the output of the bucket 312. As illustrated in FIG. 12, when the distance between a target excavation surface, which is a plane corresponding to the target excavation depth, and the axis of the third lateral shaft S3 is shorter than the distance between the axis of the third lateral shaft S3 and the edge portion 312a and the edge portion 312a is located in one of two regions separated by an imaginary, planar first boundary B1 (which is perpendicular to the target excavation surface and includes the axis of the third lateral shaft S3) that is farther from the machine body 2 than the other of the two regions, the controller 4 restricts rotation of the bucket 312 in one direction (direction to scoop earth or the like).

In other words, the first boundary B1 in the form of an imaginary plane is set so as to extend vertically or substantially vertically along the axis of the second lateral shaft S2, and when a first imaginary line L1 connecting the axis of the second lateral shaft S2 and the axis of the third lateral shaft S3 or a second imaginary line L2 connecting the axis of the second lateral shaft S2 and the edge portion 312a is present (overlaps) in a region A1 that is one of two regions A1 and A2 divided by the first boundary B1 and that is located on the far side from the machine body 2, the rotation of the bucket 312 around the third lateral shaft S3 is restricted.

In contrast, the controller 4 cancels the restriction on (does not restrict) the rotation of the bucket 312 in the one direction (direction to scoop earth, or the like) when the edge portion 312a is positioned in the other of the two regions that is closer to the machine body 2 than the first boundary B1 or when the edge portion 312a is positioned in the other of the two regions closer to the machine body 2 than the first boundary B1 and higher than the target excavation surface. In the present example embodiment, when the first imaginary line L1 connecting the axis of the second lateral shaft S2 and the axis of the third lateral shaft S3 or the second imaginary line L2 connecting the axis of the second lateral shaft S2 and the edge portion 312a is present in the region A2 which is one of the regions A1 and A2 separated by the first boundary B1 and which is closer to the machine body 2, the controller 4 cancels the restriction on the rotation of the bucket 312 about the third lateral shaft S3 and allows the operation of the bucket 312 by the manipulation lever 230.

When the distance between the target excavation surface and the axis of the third lateral shaft S3 becomes longer than the distance from the axis of the third lateral shaft S3 to the edge portion 312a, the controller 4 cancels the restriction on the rotation of the bucket 312 in the one direction (direction to scoop earth or the like). In the present example embodiment, the controller 4 sets a second boundary B2 that is perpendicular to the first boundary B1 and that divides the far-side region A1 into upper and lower portions. When the position where the bucket 312 and the arm 311 are coupled to each other (the third lateral shaft S3) is present in a lower region A3 that is one of two upper and lower regions A3 and A4 divided by the second boundary B2, the controller 4 restricts the rotation of the bucket 312 around the third lateral shaft S3. In contrast, when the position where the bucket 312 and the arm 311 are coupled to each other (the third lateral shaft S3) is present in the upper region A4, which is one of the two upper and lower regions A3 and A4 divided by the second boundary B2, the controller 4 cancels the restriction on the rotation of the bucket 312 around the third lateral shaft S3 and allows the operation of the bucket 312 by the manipulation lever 230.

The height of the second boundary B2 from the ground level in the vertical direction is set to be equal to or greater than the straight-line distance between the axis of the third lateral shaft S3 and the edge portion 312a. The height of the second boundary B2 from the ground level in the vertical direction is set to a distance obtained by adding a margin to the straight-line distance between the axis of the third lateral shaft S3 and the edge portion 312a.

In other words, in the case where the edge portion 312a of the bucket 312 approaches a target excavation depth position TL or is at the target excavation depth position TL and where the angle of the arm 311 is closer to a digging side (a shoveling side) than an angle that is determined to not require avoidance, in the case where the angle of the bucket 312 is closer to the digging side (shoveling side) than an angle that is determined to not require avoidance, or in the case where the position (the coordinates) of the end portion of the arm 311 (the third lateral shaft S3, which is the position where the arm 311 and the bucket 312 are coupled to each other) is a position located above a ground level GL at a distance equal to or greater than “the length from a second end portion of the arm 311 to the edge portion 312a of the bucket 312+a margin”, the working machine 1 (the controller 4) of the present example embodiment allows the bucket 312 to operate in response to the manipulation lever 230 being manipulated. In other cases, the output limiting function of limiting the output (rotation) of the bucket 312 is enabled.

When the first imaginary line L1 connecting the axis of the second lateral shaft S2 and the axis of the third lateral shaft S3 or the second imaginary line L2 connecting the axis of the second lateral shaft S2 and the edge portion 312a is present in the region A1, which is one of the regions A1 and A2 divided by the first boundary B1 and which is farther from the machine body 2, or when the edge portion 312a is present in the lower region A3, which is one of the two upper and lower regions A3 and A4 divided by the second boundary B2, the controller 4 changes the angular velocity of the rotation of the bucket 312 as a limitation on the rotation of the bucket 312 around the third lateral shaft S3 toward one side. In other words, the controller 4 is configured or programmed to prohibit the rotation of the bucket 312 toward the one side around the third lateral shaft S3 as the limitation on the rotation of the bucket 312 around the third lateral shaft S3 toward the one side, or the controller 4 is configured or programmed to set, as the limitation on the rotation of the bucket 312 toward the one side, a slower upper limit for the angular velocity of the rotation of the bucket 312 around the third lateral shaft S3 as the distance from the current position of the edge portion 312a to the target excavation surface decreases.

In the present example embodiment, as the change of the angular velocity of the rotation of the bucket 312 around the third lateral shaft S3, the controller 4 makes a change such that the output of the bucket 312 decreases (the angular velocity around the third lateral shaft S3 becomes slower) as the distance from the current position of the edge portion 312a of the bucket 312 to the target excavation depth position TL in the vertical direction decreases.

More specifically, the controller 4 is configured or programmed to store, in the storing unit 40, an output limiting table (map) in which the relationship between the distance from the edge portion 312a of the bucket 312 to the target excavation depth position TL in the vertical direction and the angular velocity of the bucket 312 is set beforehand. Since the working machine 1 of the present example embodiment has, as the output forms of the driving source 78, the two power modes (forms), which are the high-rotational-speed, high-power mode (HI mode) and the low-rotational-speed, low-power mode (LOW mode), to drive at a low rotational speed, an output limit map for high output and an output limit map for low output are stored in the storing unit 40. Accordingly, the controller 4 is configured or programmed to select the output limit map that corresponds to the output form of the driving source 78 and limits the output of the bucket 312 based on the selected output limit map.

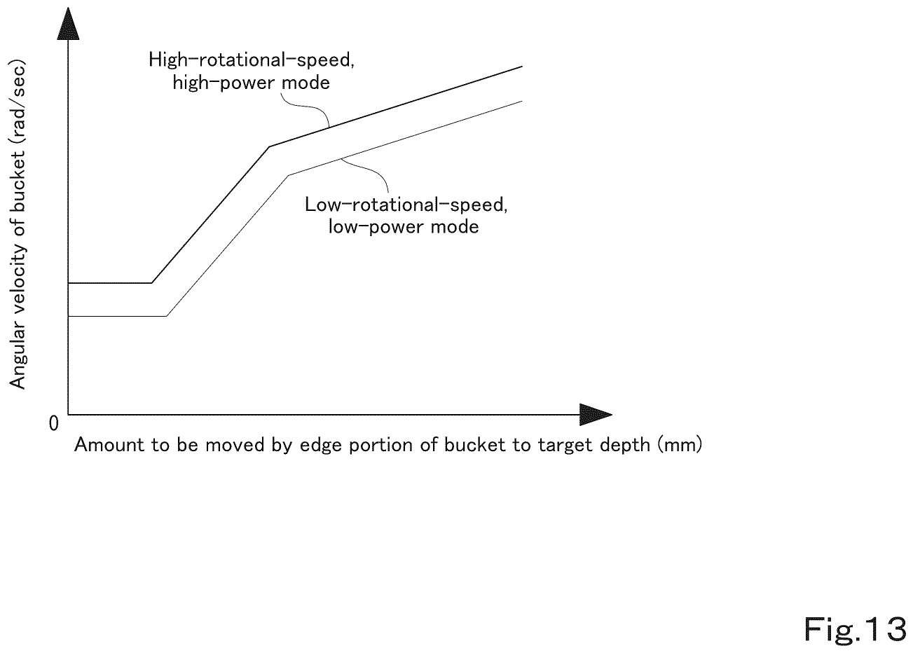

The output limit map for high output and the output limit map for low output each define the angular velocity (a swing speed) of the bucket 312 in accordance with the difference (distance) between the edge portion 312a of the bucket 312 and the target excavation depth position TL. FIG. 13 is a graph schematically illustrating the contents defined in the output limit map for the high-rotational-speed, high-power mode and the output limit map for the low-rotational-speed, low-power mode. Thus, when performing the first process (the horizontal dragging process), the controller 4 sets, upon receiving an operation command for the arm 311 and an operation command for the boom 310, the first target angular velocity and the second target angular velocity in accordance with the distance from the current position of the edge portion 312a to the target excavation depth and the power mode (output limit map) of the driving source 78.

In the present example embodiment, the output limit map for high output and the output limit map for low output are set such that, even in a state where the position of the edge portion 312a of the bucket 312 and the target excavation depth position TL coincide with each other (the distance between them is 0 (zero)), the angular velocity of the bucket 312 is set, allowing the bucket 312 to rotate, but the rotational speed of the bucket 312 is slower than the rising speed (initial speed) of the boom 310 controlled by the manipulation lever 230. In other words, in a state where the position of the edge portion 312a of the bucket 312 and the target excavation depth position TL coincide with each other (the distance between them is 0 (zero)), the angular velocity of the rotation of the bucket 312 in the direction of shoveling up earth or the like is set to a value that does not precede pulling-up of the bucket 312 accompanying the raising of the boom 310.

Thus, even if the bucket 312 rotates around the third lateral shaft S3 to shovel up earth and sand in a state where the horizontal dragging has been finished, the edge portion 312a of the bucket 312 will not pass below the target excavation depth position TL. In the working machine 1 of the present example embodiment, when the automatic excavation mode is released, the limitation on the output of the bucket 312 based on the above-mentioned criteria is released.

In the working machine 1 of the present example embodiment, when the operator has input an instruction to repeatedly perform the horizontal dragging to the input device 6, the operator manipulates the manipulation lever 230, so that the horizontal dragging is repeatedly performed based on a series of information from the previous activation. In other words, when the operator manipulates the manipulation lever 230, the bucket 312 returns to the position where the bucket 312 was located at the time of the previous activation (returns to its home position), and the horizontal dragging is automatically performed. The repetition of the horizontal dragging includes the horizontal dragging after the movement by the traveling device 5 or after the turning by the swivel base 21.

As described above, at the time of activating the bucket 312 (the former process), the working machine 1 according to the present example embodiment sets (determines), based on the position of the edge portion 312a of the bucket 312, a target angular velocity and a rotational angle that define the operation and the operating range of the arm 311, which tends to respond more quickly than the boom 310, without simply operating the arm 311 and determines the second target angular velocity and the rotational angle that correspond to (that are coordinated with) the first target angular velocity and the rotational angle, which are set. Based on this, the working machine 1 operates (rotates) the arm 311 and boom 310, and thus, the bucket 312 moves along an appropriate path at the highest speed. Therefore, the bucket 312 is prevented from excessively digging earth deeper than a target depth position, and it is also prevented that the movement causes discomfort to the operator (such as movements that feel slow or the arm 311 and the boom 310 moving separately and independently without coordination).

The target angular velocity and the rotational angle that define the operation and the operating range of the arm 311, which tends to respond more quickly than the boom 310 are set (determined) based on the position of the edge portion 312a of the bucket 312, and the second target angular velocity and the rotational angle that correspond to (that are coordinated with) the first target angular velocity and the rotational angle, which are set, are determined. Based on this, the arm 311 and boom 310 are caused to operate (rotate), and thus, the bucket 312 moves along an appropriate path at the highest speed. Therefore, the bucket 312 is prevented from excessively digging earth deeper than a target depth position, and it is also prevented that the movement causes discomfort to the operator (such as movements that feel slow or the arm 311 and the boom 310 moving separately and independently without coordination).

In the working machine 1 according to the present example embodiment, during the operation of the bucket 312 (the latter process), the input to the solenoids 732 and 732 of the valve unit 72 (control valve 73), which controls the boom cylinder 313, is determined based on the difference e between the target angular velocity and the actual angular velocity and the state of the actual angular velocity, and thus, the value of the current that is input to the solenoids 732 and 732 is corrected to an appropriate current value, thus reducing or preventing the fluctuations in the actual angular velocities of the arm 311 and the boom 310. As a result, hunting of the bucket 312 is reduced or prevented.

The working machine 1 according to the present example embodiment limits the output of the bucket 312 with reference to the state in which the edge portion 312a of the bucket 312 is at the lowest point, and thus, it is possible to prevent excessive digging associated with the operation of the bucket 312.

### Second Example Embodiment

Next, the working machine 1 according to a second example embodiment of the present invention will be described. The working machine according to the present example embodiment has a configuration similar to that of the working machine according to the first example embodiment, and thus, in the following description, the same names and reference signs will be used for the same configuration or equivalent configuration as in the first example embodiment, and the descriptions of these will be referenced from the description of the first example embodiment (to be read as the description of the second example embodiment). Accordingly, in the following description, only differences from the first example embodiment will be described.

As in the first example embodiment, the working machine 1 according to the present example embodiment has the automatic excavation mode of the working device 3 (the shovel 31), and although the controller 4 performs the former process and the latter process in the automatic excavation mode, the contents of the former process are different from those in the first example embodiment. Accordingly, in the following description, only the former process in the automatic excavation mode will be described.

In the former process in the automatic excavation mode of the working machine 1 according to the present example embodiment, the rotation (raising) of the boom 310 is controlled based on an angular acceleration (slope of angular velocity) of the boom 310 that is stored beforehand in the storing unit 40.

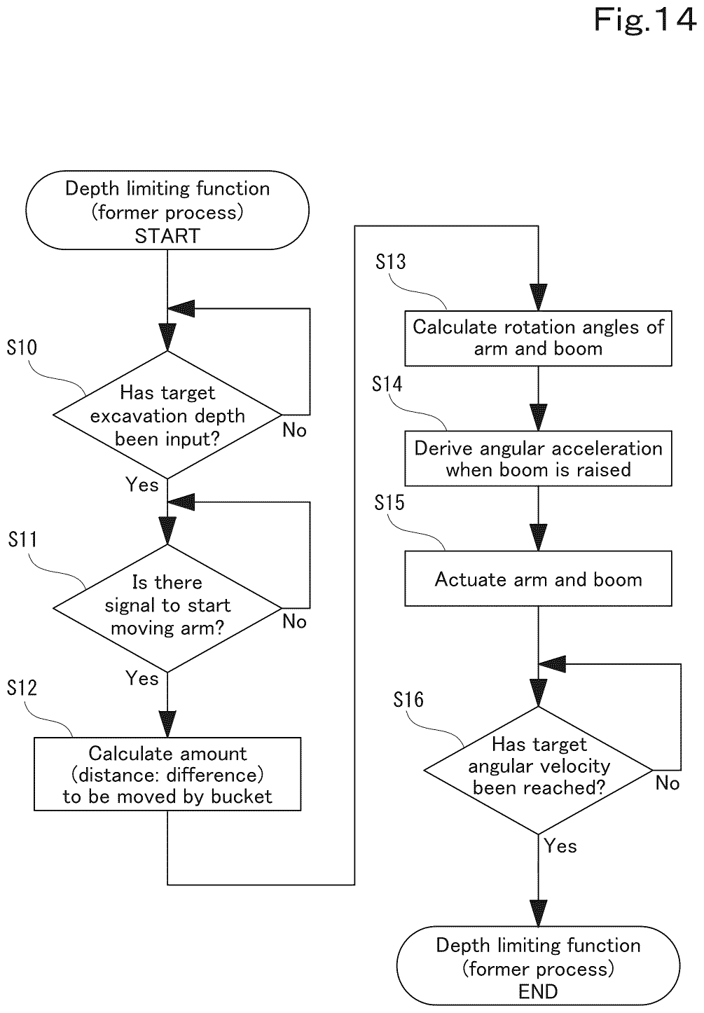

More specifically, when the controller 4 exhibits the depth limiting function (performs the depth limiting process), the controller 4 performs the former process. As in the first example embodiment, in the former process, the controller 4 (the calculator 41) determines whether the target excavation depth is input to the input device 6 (S10) and waits for the input of the target excavation depth to the input device 6 (NO in S10) as illustrated in FIG. 14. If the target excavation depth is input to the input device 6 (YES in S10), the controller 4 (the calculator 41) determines the presence or absence of a signal to activate the arm 311 (S11).

Also in the present example embodiment, when the manipulation lever 230 (see FIG. 1), which is included in the manipulator 23, is manipulated, the manipulator 23 transmits a signal to activate the arm 311 (starting the rotation of the arm 311) toward the controller 4. Thus, in the present example embodiment, the controller 4 (the calculator 41) determines whether the manipulation lever 230 is manipulated (S11) and waits until the manipulation lever 230 is manipulated (NO in S11).

If the controller 4 (the calculator 41) determines that there is the signal to activate the arm 311 (YES in S11), the controller 4 derives the distance (difference) from the current position (height position) of the edge portion 312a of the bucket 312 to the target excavation depth position in the vertical direction as the movement amount of the edge portion 312a of the bucket 312 (S12) and calculates the rotational angle of the boom 310 and the rotational angle of the arm 311 (S13). Also in the present example embodiment, the calculation of the movement amount of the edge portion rotational angles of the boom 310 and the arm 311 are performed following a procedure similar to that in the first example embodiment.

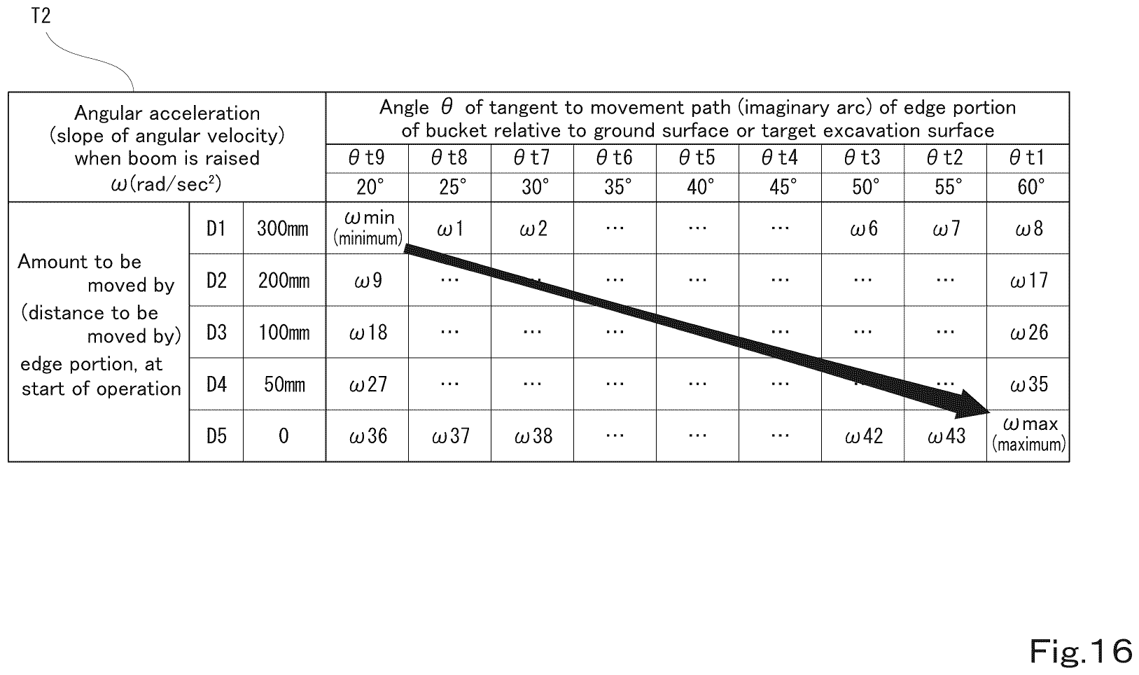

Next, the controller 4 (the calculator 41) derives the angular acceleration (slope of angular velocity) when the boom 310 is raised (S14). In other words, since it is necessary to raise the boom 310 when causing the bucket 312 to perform the horizontally pulling, the controller 4 of the present example embodiment sets the angular acceleration at the time of raising the boom 310 (S14). In the present example embodiment, the storing unit 40 of the controller 4 stores a plurality of combinations of initial differences and pieces of initial angle information and set values of the angular acceleration of the boom 310 around the first lateral shaft S1 that correspond to the plurality of combinations. Each of the initial differences is the distance from the edge portion 312a of the bucket 312 at the movement start position to the target excavation surface, which is a plane corresponding to the target excavation depth, when performing the first process (the horizontal dragging process), and each of the pieces of initial angle information is correlated with the relative angle of the arm 311 at the movement start position to the target excavation surface. In other words, the storing unit 40 of the controller 4 stores a plurality of pieces of initial angle information directly or indirectly associated with at least one of a plurality of different angles of the arm 311 and a plurality of different target excavation depths from the ground, a plurality of different movement amounts (initial differences) of the edge portion 312a of the bucket 312 when moving the edge portion 312a of the bucket 312 to the target excavation depth for excavating earth, and a plurality of angular velocities each of which is associated with a corresponding one of the plurality of pieces of initial angle information and with a corresponding one of the plurality of movement amounts and each of which is an angular acceleration of the boom 310 around the first lateral shaft S1 from the activation until a predetermined period of time passes (see FIG. 16).

Accordingly, the controller 4 (the calculator 41) is configured or programmed to extract, based on the angle of the arm 311 actually measured by the arm angle detector 46 or the information input to the input device 6, related initial angle information from the plurality of pieces of initial angle information, which are stored in the storing unit 40, and after deriving the movement amount of the bucket 312, the controller 4 (the calculator 41) is configured or programmed to derive (extract) the angular acceleration of the boom 310 that is associated with the extracted initial angle information and with the movement amount of the bucket 312.

The plurality of pieces of initial angle information stored in the storing unit 40 are pieces of information that can be directly or indirectly derived from information (angle information of the arm 311) obtained through actual measurements performed by the arm angle detector 46, the pieces of information including the angle of the arm 311 itself, the position of the end portion (the portion coupled to the bucket 312) of the arm 311 in the vertical direction, and the like. In the present example embodiment, each of the plurality of pieces of initial angle information is an angle (also referred to as an “initial tangent angle”) of a tangent at each position on a path (an imaginary circle) along which the edge portion 312a of the bucket 312 moves when the arm 311 rotates around the second lateral shaft S2, with respect to a planar target excavation surface (or the planar ground level GL). In other words, the plurality of pieces of initial angle information are each an angle of a tangent with respect to a target excavation surface (a target excavation surface as an imaginary plane at a planned position of a target depth) or with respect to the planar ground level GL that is parallel to the target excavation surface, the angle being able to be derived based on the detection result (the angle of the arm 311) obtained by the arm angle detector 46.

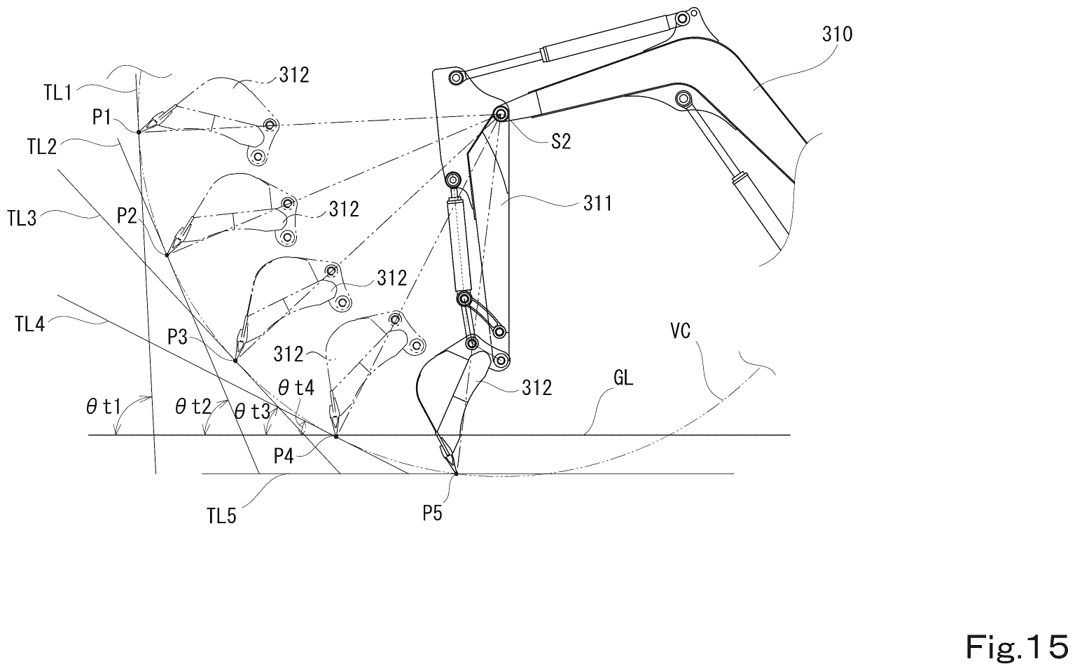

More specifically, as illustrated in FIG. 15, when the arm 311 rotates while the second lateral shaft S2 functions as a rotation fulcrum, the edge portion 312a of the bucket 312 follows the imaginary circle (an imaginary arc) VC centered on the second lateral shaft S2 as its path. In other words, the movement path VC of the edge portion 312a of the bucket 312 during the rotation of the arm 311 is the imaginary circle (imaginary arc) VC centered on the second lateral shaft S2.

Since the bucket 312 is coupled to the end portion of the arm 311, on the condition that the posture (angle) of the bucket 312 relative to the arm 311 is maintained constant, the position (placement) of the edge portion 312a of the bucket 312 on the imaginary circle (imaginary arc) VC corresponds to the posture (angle) of the arm 311. Tangents TL1 to TL5 that are tangents to the imaginary circle (imaginary arc) VC and each of which passes through a position on the imaginary circle (imaginary arc) VC where the edge portion 312a of the bucket 312 is located are perpendicular (orthogonal) to an imaginary straight line connecting the rotation fulcrum of the arm 311 and the edge portion 312a of the bucket 312 to each other.

In the present example embodiment, since the arm 311 and the boom 310 are moved while the bucket 312 is in a posture for discharging earth and sand (i.e., the bucket 312 is positioned at the dump end), the tangents TL1 to TL5 are the tangents TL1 to TL5 to the imaginary circle VC representing a path of the edge portion 312a of the bucket 312 that is positioned at the dump end.

Thus, each of the tangents TL1 to TL5 passing through a position where the edge portion 312a of the bucket 312 is located also corresponds to the posture (angle) of the arm 311. In other words, although the tangents TL1 to TL5 to the imaginary circle VC each form a right angle with the diameter (radius) of the imaginary circle VC, their angles with respect to a vertical or horizontal line passing through the center of the imaginary circle VC are different from each other depending on the positions P1 to P5 on the imaginary circle VC. Thus, the angles (postures) of the tangents TL1 to TL5 specify the positions P1 to P5 of the edge portion 312a at the position (the bucket 312) on the imaginary circle VC and thereby also specify the posture (angle) of the arm 311. Angles θt1 to θt4 of the tangents TL1 to TL5 with respect to the ground level GL correspond to the angle at which the edge portion 312a of the bucket 312 enters earth (the ground level GL) that affects digging down to the target excavation depth.

Regarding the tangents TL1 to TL5 to the imaginary circle VC (the path), through which the edge portion 312a of the bucket 312 passes, the tangents TL1 to TL5 each passing through a corresponding one of the positions P1 to P4 of the edge portion 312a of the bucket 312, tangents TL1 to TL5 angles that are the angles of the tangents TL1 to TL5 with respect to the ground level uniquely determine, from the above relationships, the relationship between the target excavation depth (depth position TL) and the angle of the arm 311 for positioning the edge portion 312a of the bucket 312 at the locations on the imaginary circle VC where the tangents TL1 to TL5 pass.

Focusing on the above-mentioned point, the working machine 1 according to the present example embodiment is configured to derive the angular acceleration (slope of angular velocity) of the boom 310 by using the angles θt1, θt2, θt3, etc., of the plurality of tangents TL1, TL2, TL3, etc., with respect to the ground level GL, the tangents having different passing points P1, P2, P3, etc., each of which corresponds to the position of the edge portion 312a of the bucket 312, on the imaginary circle VC.

More specifically, the storing unit 40 stores the plurality of combinations of the initial differences and the pieces of initial angle information and the set values of the angular acceleration of the boom 310 around the first lateral shaft S1 that correspond to the plurality of combinations. Each of the initial differences is the distance from the edge portion 312a at the movement start position to the target excavation surface, which is a plane corresponding to the target excavation depth, when performing the horizontal dragging process, and each of the pieces of initial angle information is correlated with the relative angle of the arm 311 at the movement start position to the target excavation surface.

In the present example embodiment, as illustrated in FIG. 16, the storing unit 40 stores the plurality of movement amounts D1, D2, D3, etc., that are movement amounts of the edge portion 312a as the initial differences and that are movement amounts of the edge portion 312a moves from the movement start position to the plane corresponding to the target excavation depth when performing the horizontal dragging process, the angles θt1, θt2, θt3, etc., of the tangents TL1, TL2, TL3, etc., with respect to the ground level GL, which are the pieces of initial angle information, and the plurality of angular accelerations (slopes of angular velocity) of the boom 310 each corresponding to one of the angles θt1, θt2, θt3, etc., of the plurality of tangents TL1, TL2, TL3, etc., with respect to the ground level GL.

The plurality of movement amounts (initial differences) D1, D2, D3, etc., from the edge portion 312a of the bucket 312 to the target excavation depth position TL and the plurality of slopes of angular velocity of the boom 310 are stored in the storing unit 40 in a state of being associated with each other. The angles θt1, θt2, θt3, etc., of the tangents TL1 to TL5 with respect to the ground level GL and the movement amounts D1, D2, D3, etc., of the edge portion 312a are also stored in the storing unit 40 in a state of being associated with each other.

Accordingly, as illustrated in FIG. 16, each of the angular accelerations (slopes of angular velocity) of the boom 310 is stored in association with specific one of the movement amounts D1, D2, D3, etc., and specific one of the angles θt1, θt2, θt3, etc., in the storing unit 40. In the present example embodiment, the angles θt1, θt2, θt3, etc., of the tangents TL1 to TL5 with respect to the ground level GL, the movement amounts D1, D2, D3, etc., of the edge portion 312a, and the angular accelerations (slopes of angular velocity) of the boom 310 are stored in the storing unit 40 as a table (a map) T2.

The set angular acceleration values ω1, ω2, etc., stored in the storing unit 40 are set to be higher as the movement amounts (initial differences) D1, D2, etc., of the edge portion 312a of bucket 312 decrease and are also set to be higher as the angles θt1, θt2, etc., (initial tangent angles) of the tangents TL1 to TL5 increase.

More specifically, in the correspondence among the angles θt1, θt2, θt3, etc., of the tangents TL1 to TL5 with respect to the ground level GL, the movement amounts D1, D2, D3, etc., of the edge portion 312a, and the angular accelerations (slopes of angular velocity) of the boom 310 stored in the table T2, as the angles θt1, θt2, θt3, etc., of the tangents TL1 to TL5 with respect to the ground level GL increase, the angular accelerations (slopes of angular velocity) of the boom 310 during the raising of the boom 310 increase. In addition, as the movement amounts D1, D2, D3, etc., of the edge portion 312a decrease, the angular accelerations (slopes of angular velocity) of the boom 310 during the raising of the boom 310 increase.

As a result, among the angular accelerations (slopes of angular velocity) of the boom 310 during the raising of the boom 310, which are stored in the table T2, the angular acceleration (slope of angular velocity) that is associated with the minimum angle θt9 among the angles of the tangents with respect to the ground level GL and with the largest (maximum) movement amount D1 among the movement amounts of the edge portion 312a is the smallest. Among the angular accelerations (slopes of angular velocity) of the boom 310 during the raising of the boom 310, which are stored in the table T2, the angular acceleration (slope of angular velocity) that is associated with the maximum angle θt1 among the angles of the tangents with respect to the ground level GL and with the smallest (minimum) movement amount D5 among the movement amounts of the edge portion 312a is the largest.

In the present example embodiment, the correspondence among the angles θt1, θt2, θt3, etc., of the tangents TL1 to TL5 with respect to the ground level GL, the movement amounts (initial differences) D1, D2, D3, etc., of the edge portion 312a, and the angular accelerations (slopes of angular velocity) of the boom 310 is verified through operational verification using the actual machine (the actual working machine 1). The symbols (reference signs) in the table illustrated in FIG. 16 do not correspond to the symbols (reference signs) indicating the angles of the tangents illustrated in FIG. 15.

The tangents TL1 to TL5 with respect to the imaginary circle (imaginary arc) VC, which is the movement path of the edge portion 312a of the bucket 312, are each a straight line perpendicular to an imaginary straight line connecting the second lateral shaft S2 and the edge portion 312a of the bucket 312 to each other.

In a state where the bucket 312 is in a specific posture (e.g., a posture in which it is at the maximum dump position), the imaginary straight line connecting the second lateral shaft S2 and the edge portion 312a of the bucket 312 to each other becomes constant in relation to an imaginary straight line connecting the second lateral shaft S2 and the third lateral shaft S3 and an imaginary straight line connecting the third lateral shaft S3 and the edge portion 312a of the bucket 312, and thus, the angle of the imaginary straight line connecting the second lateral shaft S2 and the edge portion 312a of the bucket 312 from the angle of the imaginary straight line connecting the second lateral shaft S2 and the third lateral shaft S3 (the angle of the arm 311).

Accordingly, the controller 4 (the calculator 41) calculates the angles of the tangents TL1, TL2, etc., with respect to the ground level GL, which are the pieces of initial angle information, based on the detection result obtained by the boom angle detector 45, the detection result obtained by the arm angle detector 46, and the target excavation depth.

The controller 4 (the calculator 41) of the present example embodiment is configured or programmed to calculate the angles of the tangents TL1, TL2, etc., with respect to the ground level GL, which are the pieces of initial angle information, based on the angle detected by the bucket angle detector 48 and the target excavation depth in addition to the detection result obtained by the boom angle detector 45 and the detection result obtained by the arm angle detector 46.

The controller 4 (the calculator 41) is configured or programmed to calculate the angle of the imaginary straight line connecting the second lateral shaft S2 and the edge portion 312a of the bucket 312 to each other based on the detection results (the angle of the boom 310, the angle of the arm 311, and the angle of the bucket 312) obtained by the angle detectors 45, 46, and 48 and the target excavation depth and calculates (determines) the angles θt1, θt2, θt3, . . . of the tangents TL1 to TL5 with respect to the ground level GL based on the calculated angle of the imaginary straight line.

Then, the controller 4 (the calculator 41) is configured or programmed to derive (extracts), from the table (map) T2 stored in the storing unit 40, the corresponding angular acceleration (slope of the angular velocity) of the boom 310 based on the calculated movement amounts D1, etc., of the bucket 312 and the angles θt1, etc., of the tangents that are calculated (S14).

In the case where the value of the angular acceleration corresponding to the combination of the actual initial difference and the initial angle information at the movement start position is different from each of the set values stored in the storing unit 40, the controller 4 (the calculator 41) is configured or programmed to perform an interpolation calculation for the set value of the angular acceleration corresponding to the combination of the actual initial difference and the initial angle information based on the plurality of combinations of the initial differences and the pieces of initial angle information and the set values of the angular velocity each corresponding to one of the plurality of combinations, which are stored in the storing unit 40. In other words, in the case where the angular accelerations (slopes of angular velocity) of the boom 310 corresponding to the combinations of the calculated movement amounts D1, etc., of the bucket 312 and the angles θt1, etc., of the tangents that are calculated are stored in the storing unit 40, the controller 4 (the calculator 41) calculates the angular accelerations of the boom 310 by performing interpolation calculations based on the information stored in the storing unit 40.

The controller 4 (the calculator 41) is configured or programmed to cause the boom 310 to rotate at the derived angle acceleration (slope of the angular velocity) of the boom 310 (S15). In other words, the controller 4 (the calculator 41) is configured or programmed to convert the derived angular acceleration of the boom 310 into a corresponding value of the current such that the boom 310 rotates at the derived slope of the angular velocity (angular acceleration) and instructs the valve controller 42 to input the current of the converted current value to the solenoids 732 and 732 of the valve unit 72 (the control valve 73). In addition, since there is correspondence between a change in the angle of the arm 311 and a change in the angle of the boom 310 when moving the bucket 312 from its current position to the target excavation depth, the controller 4 (the calculator 41) inputs the current to the solenoids 732 and 732 of the valve unit 72 (the control valve 73) such that the angle of the arm 311 corresponds to the angle of the boom 310 (S15). As a result, the arm 311 moves (rotates) in accordance with the posture (angle) of the boom 310 without moving ahead of the boom 310. When the boom 310 rotates by the rotational angle calculated by using the angular accelerations (slopes of angular velocity) of the boom 310 stored in the table, the angular velocity of the boom 310 reaches a maximum velocity, and the edge portion 312a reaches the target excavation depth.

In the present example embodiment, if the edge portion 312a reaches the target excavation depth position TL (YES in S16), the former process is terminated (END) and switched to the latter process. The latter process is the same as the process in the above-described first example embodiment.

As described above, in the working machine 1 according to the present example embodiment, the storing unit 40 stores the angles θt1, θt2, θt3, . . . of the tangents TL1, TL2, TL3, etc., of the imaginary circle (imaginary arc) VC, which is the movement path of the edge portion 312a of bucket 312, with respect to the ground level GL, the movement amounts D1, D2, D3, etc., of the edge portion 312a of the bucket 312 in the vertical direction, and the angular accelerations (slopes of angular velocity) of the boom 310 in association with each other, and the controller 4 (the calculator 41) derives, based on the actual situation, the angle acceleration (slope of the angular velocity) of the boom 310 from the information stored in the storing unit 40 and drives the boom 310 based on this. Therefore, the arm 311 does not move ahead of the boom 310 and is prevented from excessively digging deeper than the target excavation depth.

In particular, since the slope of the angular velocity of the boom 310 is data obtained from actual measurements taken with the actual machine, it aligns with the capability of the actual machine, resulting in a smoother operation of arm 311 and a smoother operation of boom 310.

The working machines 1 according to the first example embodiment and the second example embodiment of the present invention preferably are as described above, and (an example embodiment of) the present invention provides the working machine 1 described in the following items.

(Item 1-1) A working machine 1 including a machine body 2, a boom 310 coupled to the machine body 2 such that the boom 310 is rotatable about a first lateral shaft S1, an arm 311 coupled to a distal portion of the boom 310 such that the arm 311 is rotatable about a second lateral shaft S2, a bucket 312 coupled to a distal portion of the arm 311 and including an edge portion 312a located away from a junction of the bucket 312 and the arm 311, the edge portion 312a being a leading edge when the bucket 312 excavates earth, and a controller 4 configured or programmed to control rotation of the boom 310 and the arm 311, wherein the controller 4 is configured or programmed to, in performing a first process in which the controller 4 causes the arm 311 to rotate about the second lateral shaft S2 toward the boom 310 while causing the boom 310 to rotate about the first lateral shaft S1 to move up to perform excavation along a plane at a target excavation depth, set a first target angular velocity of the arm 311 and a second target angular velocity of the boom 310 based on a distance between the edge portion 312a in a movement start position and the target excavation depth, the first target angular velocity being a target angular velocity corresponding to a period of time elapsed from a start of movement of the arm 311, the second target angular velocity being a target angular velocity corresponding to a period of time elapsed from a start of movement of the boom 310, and control rotation of the arm 311 and the boom 310 based on the set first target angular velocity and the set second target angular velocity.

With the working machine 1 according to item 1-1, the controller 4 is configured or programmed to, in performing a first process in which the controller 4 causes the arm 311 to rotate about the second lateral shaft S2 toward the boom 310 while causing the boom 310 to rotate about the first lateral shaft S1 to move up to perform excavation along a plane a target excavation depth, set target angular velocities for the arm 311 and the boom 310 (a first target angular velocity and a second target angular velocity) based on the distance between the edge portion 312a in the movement start position and the target excavation depth, and control the rotation of the arm 311 and the boom 310 based on the set first target angular velocity and the set second target angular velocity. This makes it possible to move the bucket 312 in a way that is suitable for the position of the edge portion 312a. This eliminates or reduces the likelihood that the bucket 312 will excavate too deep.

(Item 1-2) The working machine 1 according to item 1-1, wherein the controller 4 is configured or programmed to set the first target angular velocity such that, as the distance between the edge portion 312a in the movement start position and the target excavation depth becomes smaller, an initial angular velocity of the arm 311 becomes smaller and an angular acceleration during a predetermined first period of time elapsed from the start of movement becomes greater, and set the second target angular velocity according to the first target angular velocity.

With the working machine 1 according to item 1-2, the controller 4 is configured or programmed to set the first target angular velocity such that, as the distance between the edge portion 312a in the movement start position and the target excavation depth becomes smaller, the initial angular velocity of the arm 311 becomes smaller and the angular acceleration during a predetermined first period of time elapsed from the start of movement becomes greater. This eliminates or reduces the likelihood that the edge portion 312a of the bucket 312 will move abruptly when starting to move, when the amount to be moved by the edge portion 312a of the bucket 312 is small. That is, when the amount to be moved by the edge portion 312a of the bucket 312 is small (when the distance to be moved by the edge portion 312a is small), the bucket 312 (edge portion 312a) starts moving slowly.

This eliminates or reduces the likelihood that the edge portion 312a of the bucket 312 will move deeper than the target excavation depth (excavate too deep) as the arm 311 starts moving. Furthermore, since the controller 4 sets the first target angular velocity of the arm 311 about the second lateral shaft S2 such that, as the distance between the edge portion 312a of the bucket 312 and the target excavation depth becomes smaller (as the amount to be moved by the edge portion 312a becomes smaller), the angular acceleration during a predetermined first period of time elapsed from the start of movement becomes greater. Thus, the edge portion 312a of the bucket 312 quickly moves the amount to be moved to reach the target excavation depth.

Furthermore, since the controller 4 sets the second target angular velocity of the boom 310 about the first lateral shaft S1 based on the first target angular velocity, the movement (rotation) of the boom 310 is based on the rotation of the arm 311, making it possible to eliminate or reduce the likelihood that the boom 310 will move slower than the arm 311. Since the controller 4 causes the arm 311 to rotate at the first target angular velocity and causes the boom 310 to rotate at the second target angular velocity, it is possible to eliminate or reduce the likelihood that the edge portion 312a of the bucket 312 will move more than the amount to be moved to reach the target depth (excavate deeper than the target depth), and possible to cause the edge portion 312a of the bucket 312 to reach the desired position in a predetermined period of time. Thus, the working machine 1 according to item 1-2 makes it possible to, during excavation, prevent or reduce excavation deeper than the target excavation depth, and possible to move the bucket 312 quickly without giving a feeling of strangeness to the user.

(Item 1-3) The working machine 1 according to item 1-2, wherein the controller 4 is configured or programmed to set the first target angular velocity such that the first target angular velocity increases during the first period of time elapsed from the start of movement and is constant after the first period of time has elapsed.

With the working machine 1 according to item 1-3, the bucket 312 coupled to the distal portion of the arm 311 moves also in a way that corresponds to the rotation of the arm 311. That is, since the first target angular velocity is set such that it increases during the first predetermined period of time elapsed from the start of movement and then is constant, the bucket 32 also increases in velocity and then moves at a constant velocity. Thus, since the bucket 312 increases in velocity and then moves at a constant velocity, the bucket 312 moves such that the inertial force is less than when the bucket 312 increases in velocity. This eliminates or reduces the likelihood that the edge portion 312a of the bucket 312 will move deeper than the target excavation depth due to the inertial force.

(Item 1-4) The working machine 1 according to any one of items 1-1 to 1-3, wherein the controller 4 is configured or programmed to set the second target angular velocity such that the second target angular velocity increases during a second period of time elapsed from the start of movement and is constant after the second period of time has elapsed, and set the second period of time such that the second period of time becomes longer as the distance becomes greater.

With the working machine 1 according to item 1-4, the bucket 312 coupled to the boom 310 via the arm 311 moves also in a way that corresponds to the rotation of the boom 310. That is, since the second target angular velocity is set such that it increases during the second predetermined period of time elapsed from the start of movement and then is constant, the bucket 32 also increases in velocity and then moves at a constant velocity. Thus, since the bucket 312 increases in velocity and then moves at a constant velocity, the bucket 312 moves such that the inertial force is less than when bucket 312 increases in velocity. This eliminates or reduces the likelihood that the edge portion 312a of the bucket 312 will move deeper than the target excavation depth due to the inertial force.

(Item 1-5) The working machine 1 according to any of items 1-1 to 1-4, further including an arm cylinder 314 to extend and retract by receiving and discharging hydraulic fluid to rotate the arm 311, a boom cylinder 313 to extend and retract by receiving and discharging hydraulic fluid to rotate the boom 310, an arm control valve 73 including a solenoid 732, 732 to switch supplying and discharging hydraulic fluid to and from the arm cylinder 314 and to adjust a flow rate of hydraulic fluid based on a current value inputted thereto, and a boom control valve 73 including a solenoid 732, 732 to switch supplying and discharging hydraulic fluid to and from the boom cylinder 313 and to adjust a flow rate of hydraulic fluid based on a current value inputted thereto, wherein the controller 4 is configured or programmed to supply a current corresponding to the first target angular velocity to the solenoid 732, 732 of the arm control valve 73 and supply a current corresponding to the second target angular velocity to the solenoid 732, 732 of the boom control valve 73.

With the working machine 1 according to item 1-5, the controller 4 is configured or programmed to supply electric current corresponding to the first target angular velocity to the solenoid(s) 732 of the arm control valve 73, and supply electric current corresponding to the second target angular velocity to the solenoid(s) 732 of the boom control valve 73, and therefore the arm cylinder 314 is supplied with hydraulic fluid in an amount that achieves the first target angular velocity and the boom cylinder 313 is supplied with hydraulic fluid in an amount that achieves the second target angular velocity. With this, also in cases where the arm cylinder 314 and the boom cylinder 313 are hydraulic cylinders, the arm 311 and the boom 310 can be actuated in a manner that achieves the foregoing effect(s).

(Item 1-6) The working machine 1 according to item 1-5, further including a hydraulic pump 71 to deliver hydraulic fluid toward the arm cylinder 314 and the boom cylinder 313, and a driving source 78 to drive the hydraulic pump 71, wherein the controller 4 is configured or programmed to, when performing the first process, set the first target angular velocity and the second target angular velocity based on a distance between the edge portion 312a and the target excavation depth and an output of the driving source 78 at a time of receipt of an instruction to actuate the arm 311 and the boom 310.

With the working machine 1 according to item 1-6, the controller 4 is configured or programmed to, when performing the first process, set the first target angular velocity and the second target angular velocity based on the distance between the edge portion 312a and the target excavation depth and the output of the driving source 78 at the time of receipt of an instruction to actuate the arm 311 and the boom 310, and therefore, even if there are fluctuations (variations in magnitude) in the output of the driving source 78, the arm 311 and the boom 310 can be rotated in a manner that corresponds to the state (mode) of the output of the driving source 78 and the distance moved by the bucket 312.

(Item 1-7) The working machine 1 according to item 1-6, wherein the driving source 78 is operable to switch a power mode thereof between a low-power mode in which the driving source 78 produces output in a low-power range included in a power range thereof, and a high-power mode in which the driving source 78 produces output higher than the low-power range included in the power range thereof, and the controller 4 is configured or programmed to, when performing the first process, set the first target angular velocity and the second target angular velocity based on the distance between the edge portion 312a and the target excavation depth and the power mode of the driving source 78 at the time of receipt of the instruction to actuate the arm 311 and the boom 310.

With the working machine 1 according to item 1-7, the first target angular velocity and the second target angular velocity are set based on the output state (mode) of the driving source 78, and therefore, even if there are fluctuations (variations in magnitude) in the output of the driving source 78, the arm 311 and the boom 310 can be rotated in a manner that corresponds to the state (mode) of the output of the driving source 78.

(Item 1-8) The working machine 1 according to item 1-7, wherein the controller 4 is configured or programmed to set an initial angular velocity of the arm 311 using Equation (1) below, set a rate of increase of an angular velocity of the arm 311 during a predetermined period of time elapsed from the start of movement using Equation (2) below, and set the first target angular velocity during the predetermined period of time elapsed from the start of movement using Equation (3) below.

Initial angular velocity ωs=(P×k)−Nd Equation (1)

Rate of increase α of angular velocity=(ωmax−ωs)/Ta Equation (2)

First target acceleration=α×Tb+ωs Equation (3),
where P represents the distance between the edge portion 312a and the target excavation depth at a time of the start of movement,
k represents a preset coefficient,
Nd represents a difference of the output of the driving source 78 from an output in the high-power mode,
ωmax represents an estimated maximum angular velocity of the arm 311 corresponding to the output of the driving source 78,
Ta represents time taken to reach the maximum angular velocity, and
Tb represents a period of time elapsed from the start of movement.

With the working machine 1 according to item 1-8, the arm 311 is actuated at the first target angular velocity derived using Equation (3), and therefore the arm 311 moves in an ideal manner. More specifically, “α×Tb” in Equation (3), i.e., “(ωmax−ωs)/Ta×Tb” obtained by substituting Equation (2) into Equation (3), represents the slope of the graph in which the horizontal axis indicates a period of time elapsed and the vertical axis represents the target angular velocity, and “ωs” in Equation (3), i.e., “(P×k)−Nd” in Equation (1), represents the intercept of the same graph. Therefore, “(ωmax−ωs)/Ta×Tb” is an expression that represents the angular acceleration of the arm 311 per unit time, i.e., the angular acceleration with which the arm 311 accelerates during a specific period of time, and “(P×k)−Nd” is an expression that represents the initial angular velocity of the arm 311.

With this, when the arm 311 starts moving (when the angular velocity is substantially zero), the arm 311 moves at an expected velocity that does not cause the bucket 312 to excavate deeper than the target excavation depth and that does not give a sense of strangeness to the user about the movement of the arm 311, or at a velocity closer to the expected velocity. In particular, in “((P×k)−Nd)” of Equation (1) to determine the initial angular velocity, the coefficient k based on the actual measurement and the difference Nd corresponding to the rotational speed of the driving source 78 are taken into consideration, and therefore the initial angular velocity has an ideal value, which is an appropriate value suitable for the operational state of the working machine 1 (driving source 78). Thus, when the controller 4 causes the arm 311 to rotate about the second lateral shaft S2 at the first target angular velocity derived using Equation (3), the bucket 312 moves in an ideal manner.

(Item 1-9) The working machine 1 according to any one of items 1-1 to 1-8, wherein the controller 4 is configured or programmed to derive the second target angular velocity by multiplying the first target angular velocity by a predetermined reflection coefficient set such that the second target angular velocity is lower than the first target angular velocity.

With the working machine 1 according to item 1-9, since the second target angular velocity is derived by multiplying the first target angular velocity by a predetermined reflection coefficient set such that the second target angular velocity is lower than the first target angular velocity, the second target angular velocity and the first target angular velocity are not derived independently of each other, and the relationship between the second target angular velocity and the first target angular velocity is constant. Therefore, the boom 310 and the arm 311 move in a related, ideal manner.

(Item 2-1) A working machine 1 including a machine body 2, a boom 310 coupled to the machine body 2 such that the boom 310 is rotatable about a first lateral shaft S1, an arm 311 coupled to a distal portion of the boom 310 such that the arm 311 is rotatable about a second lateral shaft S2, a bucket 312 coupled to a distal portion of the arm 311 and including an edge portion 312a located away from a junction of the bucket 312 and the arm 311, the edge portion 312a being a leading edge when the bucket 312 excavates earth, and a controller 4 configured or programmed to control rotation of the boom 310 and the arm 311, wherein the controller 4 is configured or programmed to include a memory and/or a storage 40 to store (i) a plurality of combinations of an initial difference and initial angle information and (ii) set values of angular acceleration of the boom 310 about the first lateral shaft S1 that correspond to the plurality of combinations, the initial difference being a distance between a target excavation surface and the edge portion 312a in a movement start position in the first process, the target excavation surface being a plane corresponding to the target excavation depth, the first process being a process in which the controller 4 causes the arm 311 to rotate about the second lateral shaft S2 toward the boom 310 while causing the boom 310 to rotate about the first lateral shaft S1 to move up to perform excavation along a plane at the target excavation depth, the initial angle information being correlated with an angle of the arm 311 in a movement start position relative to the target excavation surface, set, based on one of the set values that corresponds to a corresponding combination of the initial difference and the initial angle information when the arm 311 is in the movement start position, an angular acceleration of the boom 310 about the first lateral shaft S1 during a predetermined period of time elapsed from a start of movement, and control rotation of the boom 310 based on the set angular acceleration.

With the working machine 1 according to item 2-1, the memory and/or the storage 40 of the controller 4 stores (i) a plurality of combinations of an initial difference (which is the distance between the target excavation surface, which is a plane corresponding to the target excavation depth, and the edge portion 312a in the movement start position in the first process) and initial angle information (which is correlated with an angle of the arm 311 in the movement start position relative to the target excavation surface) and (ii) set values of angular acceleration of the boom 310 about the first lateral shaft S1 that correspond to the plurality of combinations, the first process being a process in which the controller 4 causes the arm 311 to rotate about the second lateral shaft S2 toward the boom 310 while causing the boom 310 to rotate about the first lateral shaft S1 to move up to perform excavation at the target excavation depth. The controller 4 then causes the boom 310 to rotate at the angular velocity (angular acceleration) set based on the set value (set value corresponding to the combination of the initial difference and the initial angle information) stored in the memory and/or the storage 40, and therefore the boom 310 rotates with an angular acceleration (angular velocity) that is suitable for the current conditions.

With this, the rotation of the boom 310 does not adversely affect the movement of the bucket 312, allowing the bucket 312 to move at the target excavation depth. Therefore, the working machine 1 according to item 2-1 prevents or reduces excavation deeper than the expected target excavation depth when excavating.

(Item 2-2) The working machine 1 according to item 2-1, wherein the initial angle information includes an initial tangent angle indicating an angle, relative to the target excavation surface when the edge portion is in the movement start position, of a tangent T11 to TL5 to an imaginary circle VC defined by a path of movement of the edge portion 312a of the bucket 312 around the second lateral shaft S2.

With the working machine 1 according to item 2-2, the initial angle information includes the angle, relative to the target excavation surface, of each of tangents T11 to TL5 to respective portions of an imaginary circle VC defined by the path of movement of the edge portion 312a of the bucket 312 (initial tangent angles). Thus, the initial angle information is closely related to the angle of the arm 311. Furthermore, the tangents TL1 to TL5 to the imaginary circle VC are related to the position and/or the orientation of the edge portion 312a of the bucket 312 (direction in which the edge portion 312a of the bucket 312 enters earth), and therefore, by deriving the angular acceleration of the boom 310 based on the tangent(s) TL1 to TL5, the boom 310 can be rotated (moved upward) in a manner that suits the actual conditions (in a manner that suits the state of the arm 311). This makes it possible to eliminate or reduce the likelihood that the boom 310 will rotate after the rotation of the arm 311 and therefore the edge portion 312a of the bucket 312 will excavate deeper than the target excavation depth.

(Item 2-3) The working machine 1 according to item 2-2, wherein the set values of angular acceleration stored in the memory and/or the storage 40 are set greater for smaller initial differences and set greater for larger initial tangent angles.

With the working machine 1 according to item 2-3, the set values of angular acceleration stored in the memory and/or the storage 40 are set greater for smaller initial differences and set greater for larger initial tangent angles, making it possible to eliminate or reduce the likelihood that the edge portion 312a of the bucket 312 will move more than the target amount (target excavation depth). Specifically, the angular acceleration of the boom 310 is such that the boom 310 moves upward more quickly as the initial difference (the amount to be moved by the edge portion 312a of the bucket 312) becomes smaller and the initial tangent angle increases. More specifically, in the case where the angles of the tangents TL1 to TL5 are large, the angle at which the edge portion 312a of the bucket 312 contacts the target excavation surface is also large, and therefore, in cases where the initial difference (the amount to be moved by the edge portion 312a) is small, if the boom 310 moves upward with delay, the edge portion 312a of the bucket 312 may move more than the expected amount of movement (target excavation depth). However, with the working machine 1 according to item 2-3, as described above, the set values of angular acceleration are set greater for smaller initial differences and set greater for larger initial tangent angles. Thus, the boom 310 is raised quickly, making it possible to eliminate or reduce the likelihood that the edge portion 312a of the bucket 312 will move more than the expected amount (target excavation depth).

(Item 2-4) The working machine 1 according to any one of items 2-1 to 2-3, further including a boom angle detector 45 to detect an angle of rotation of the boom 310 about the first lateral shaft S1 with respect to the machine body 2, and an arm angle detector 46 to detect an angle of rotation of the arm 311 about the second lateral shaft S2 with respect to the boom 310, wherein the controller 4 is configured or programmed to calculate the initial angle information based on a detection result from the boom angle detector 45, a detection result from the arm angle detector 46, and the target excavation depth.

With the working machine 1 according to item 2-4, the controller 4 is configured or programmed to calculate the initial angle information based on a detection result from the boom angle detector 45, a detection result from the arm angle detector 46, and the target excavation depth, and therefore the initial angle information corresponds to the actual posture (angle) of the boom 310 and the arm 311. Thus, since the boom 310 is caused to rotate at the angular velocity (angular acceleration) set based on one of the set values included in the information stored in the memory and/or the storage 40 that includes the calculated initial angle information and its corresponding initial difference (set value corresponding to the combination of the initial difference and the initial angle information), the boom 310 rotates with an angular acceleration (angular velocity) that is more suitable for the current conditions. Therefore, the working machine 1 according to item 2-4 reliably prevents or reduces excavation deeper than the expected target excavation depth when excavating.

(Item 2-5) The working machine 1 according to any one of items 2-1 to 2-4, wherein the working machine 1 includes a bucket angle detector 48 to detect an angle of rotation of the bucket 312 about the third lateral shaft S3 with respect to the arm 311, and the controller 4 is configured or programmed to calculate the initial angle information based on a detection result from the boom angle detector 45, a detection result from the arm angle detector 46, a detection result from the bucket angle detector 48, and the target excavation depth.

With the working machine 1 according to item 2-5, the controller 4 is configured or programmed to calculate the initial angle information based on a detection result from the boom angle detector 45, a detection result from the arm angle detector 46, a detection result from the bucket angle detector 48, and the target excavation depth, and therefore the derived (calculated) initial angle information corresponds to not only the actual posture (angle) of the boom 310 and the arm 311 but also the actual posture (angle) of the bucket 312. Thus, since the boom 310 is caused to rotate at the angular velocity (angular acceleration) set based on one of the set values included in the information stored in the memory and/or the storage 40 that includes the calculated initial angle information and its corresponding initial difference (set value corresponding to the combination of the initial difference and the initial angle information), the boom 310 rotates with an angular acceleration (angular velocity) that is more suitable for the current conditions. Therefore, the working machine 1 according to item 2-5 more reliably prevents or reduces excavation deeper than the expected target excavation depth when excavating.

(Item 2-6) The working machine 1 according to any one of items 2-1 to 2-5, wherein the controller 4 is configured or programmed to, if a value of the angular acceleration corresponding to a combination of the actual initial difference and the actual initial angle information when the arm is in the movement start position is other than the set values stored in the memory and/or the storage 40, interpolate a set value of the angular acceleration corresponding to the combination of the actual initial difference and the initial angle information based on the plurality of combinations of the initial difference and the initial angle information stored in the memory and/or the storage 40 and set values of the angular velocity that correspond to the plurality of combinations.

With the working machine 1 according to item 2-6, the controller 4 is configured or programmed to interpolate a set value of the angular acceleration corresponding to the combination of the actual initial difference and the initial angle information based on the plurality of combinations of the initial difference and the initial angle information stored in the memory and/or the storage 40 and set values of an angular velocity that correspond to the plurality of combinations, and therefore, even in cases of condition (initial difference or initial angle information) not stored in the memory and/or the storage 40, by deriving an angular velocity that is suitable for the situation and causing the boom 310 to rotate at the derived angular velocity (angular acceleration), it is possible to cause the boom 310 to rotate (move upward) in a manner that suits the actual conditions (in a manner that suits the state of the arm 311). This makes it possible to eliminate or reduce the likelihood that the boom 310 will rotate slower than the arm 311 and therefore the edge portion 312a of the bucket 312 will excavate deeper than the target excavation depth.

(Item 2-7) The working machine 1 according to any one of items 2-1 to 2-6, further including a boom cylinder 313 to extend and retract by receiving and discharging hydraulic fluid to rotate the boom 310, and a boom control valve 73 including a solenoid 732, 732 to switch supplying and discharging hydraulic fluid to and from the boom cylinder 313 and to adjust a flow rate of hydraulic fluid based on a current value inputted thereto, wherein the controller 4 is configured or programmed to supply a current corresponding to an angular acceleration of the boom 310 to the solenoid 732, 732 of the boom control valve 73.

With the working machine 1 according to item 2-7, the controller 4 is configured or programmed to supply electric current corresponding to the angular acceleration of the boom 310 to the solenoid 732 of the boom control valve 73, and therefore the boom cylinder 313 to rotate the boom 310 is actuated in a manner appropriate for the situation. With this, the boom 310 operates at a velocity (acceleration) appropriate for the situation, eliminating or reducing the likelihood that the edge portion 312a of the bucket 312 will excavate more than the target excavation depth.

(Item 3-1) A working machine 1 including a machine body 2, a boom 310 coupled to the machine body 2 such that the boom 310 is rotatable about a first lateral shaft S1, an arm 311 coupled to a distal portion of the boom 310 such that the arm 311 is rotatable about a second lateral shaft S2, a bucket 312 coupled to a distal portion of the arm 311 and including an edge portion 312a located away from a junction of the bucket 312 and the arm 311, the edge portion 312a being a leading edge when the bucket 312 excavates earth, a rotation sensor 45, 46, 48 to measure rotation of a to-be-measured object which is at least one of the boom 310, the arm 311, or the bucket 312, and a controller 4 configured or programmed to control rotation of the to-be-measured object, wherein the controller 4 is configured or programmed to control rotation of the to-be-measured object based on an output value obtained by applying a correction function directly or indirectly to a difference e between a target angular velocity for when the to-be-measured object rotates and an actual angular velocity of the to-be-measured object that is derived based on a measurement result from the rotation sensor 45, 46, 48, the correction function being based on the actual angular velocity.

With the working machine 1 according to item 3-1, the controller 4 is configured or programmed to control rotation of the to-be-measured object based on an output value obtained by applying a correction function (which is based on the actual angular velocity) directly or indirectly to a difference e between the target angular velocity for when the to-be-measured object rotates and the actual angular velocity of the to-be-measured object that is derived based on a measurement result from the rotation sensor 45, 46, 48. Therefore, the to-be-measured object, which is at least one of the boom 310, the arm 311, or the bucket 312, rotates at an ideal target angular velocity or at an angular velocity very close to the target angular velocity.

Specifically, if the difference e between the target angular velocity and the actual angular velocity, as the output value, is applied to the rotation of the to-be-measured object that is continuously rotating (that keeps changing in its status), since the rotating state of the to-be-measured object may change from when it was rotating at the actual angular velocity from which the difference e was derived, the output value may not match the actual situations and the rotation of the to-be-measured object may not match the target angular velocity. However, when a correction function based on the actual angular velocity is directly or indirectly applied to the difference e between the target angular velocity for rotation of the to-be-measured object and the actual angular velocity of the to-be-measured object that is derived based on a measurement result from the rotation sensor 45, the resulting output value corresponds to the actual rotating state of the to-be-measured object.

Thus, when the output, which is obtained by applying a correction function based on the actual angular velocity of the to-be-measured object to the difference e between the target angular velocity and the actual angular velocity, is applied to the rotation of the to-be-measured object, the to-be-measured object rotates at the target angular velocity or at an angular velocity close to the target angular velocity. This enables the to-be-measured object to rotate smoothly, preventing or reducing the vibrations of the bucket 312 coupled to the boom 310 via the arm 311, and reducing the occurrence of hunting in the bucket 312 during horizontal dragging. Thus, the working machine 1 according to item 3-1 makes it possible to correct the rotation of the to-be-measured object which is at least one of the boom 310, the arm 311, or the bucket 312, and prevent or reduce the occurrence of hunting in the bucket 312.

(Item 3-2) The working machine 1 according to item 3-1, wherein the rotation sensor 45 is operable to measure rotation of the boom 310, which is the to-be-measured object, about the first lateral shaft S1, and the controller 4 is configured or programmed to control rotation of the boom 310 based on the output value obtained by applying the correction function based on the actual angular velocity directly or indirectly to the difference e between the target angular velocity for when the boom 310, which is the to-be-measured object, rotates about the first lateral shaft S1 and the actual angular velocity of the boom 310 that is derived based on the measurement result from the rotation sensor 45.

With the working machine 1 according to item 3-2, the controller 4 is configured or programmed to control rotation of the boom 310 based on the output value obtained by applying, directly or indirectly, the correction function based on the actual angular velocity to the difference e between the target angular velocity for when the boom 310, which is the to-be-measured object, rotates about the first lateral shaft S1 and the actual angular velocity of the boom 310 that is derived based on the measurement result from the rotation sensor 45. Therefore, the boom 310 rotates at the target angular velocity or at an angular velocity close to the target angular velocity. This enables the boom 310 to rotate smoothly, preventing or reducing the vibrations of the bucket 312 coupled to the boom 310 via the arm 311, and preventing or reducing the occurrence of hunting in the bucket 312 during horizontal dragging.

(Item 3-3) The working machine 1 according to item 3-1, wherein the rotation sensor 46 is operable to measure rotation of the arm 311, which is the to-be-measured object, about the second lateral shaft S2, and the controller 4 is configured or programmed to control rotation of the arm 311 based on the output value obtained by applying the correction function based on the actual angular velocity directly or indirectly to the difference e between the target angular velocity for when the arm 311, which is the to-be-measured object, rotates about the second lateral shaft S2 and the actual angular velocity of the arm 311 that is derived based on the measurement result from the rotation sensor 46.

With the working machine 1 according to item 3-3, the controller 4 is configured or programmed to control rotation of the arm 311 based on the output value obtained by applying the correction function based on the actual angular velocity directly or indirectly to the difference e between the target angular velocity for when the arm 311, which is the to-be-measured object, rotates about the second lateral shaft S2 and the actual angular velocity of the arm 311 that is derived based on the measurement result from the rotation sensor 46. Therefore, the arm 311 rotates at the target angular velocity or at an angular velocity close to the target angular velocity. This enables the arm 311 to rotate smoothly, preventing or reducing the vibrations of the bucket 312 coupled to the boom 310 via the arm 311, and preventing or reducing the occurrence of hunting in the bucket 312 during horizontal dragging.

(Item 3-4) The working machine 1 according to item 3-1, wherein the rotation sensor 48 is configured or programmed to measure rotation of the bucket 312, which is the to-be-measured object, about a third lateral shaft S3, and the controller 4 is configured or programmed to control rotation of the bucket 312 based on the output value obtained by applying the correction function based on the actual angular velocity directly or indirectly to the difference e between the target angular velocity for when the bucket 312, which is the to-be-measured object, rotates about the third lateral shaft S3 and the actual angular velocity of the bucket 312 that is derived based on the measurement result from the rotation sensor 48.

With the working machine 1 according to item 3-4, the controller 4 is configured or programmed to control rotation of the bucket 312 based on the output value obtained by applying the correction function based on the actual angular velocity directly or indirectly to the difference e between the target angular velocity for when the bucket 312, which is the to-be-measured object, rotates about the third lateral shaft S3 and the actual angular velocity of the bucket 312 that is derived based on the measurement result from the rotation sensor 48. Therefore, the bucket 312 rotates at the target angular velocity or at an angular velocity close to the target angular velocity. This enables the bucket 312 to rotate smoothly, preventing or reducing the vibrations of the bucket 312 coupled to the boom 310 via the arm 311, and preventing or reducing the occurrence of hunting in the bucket 312 during horizontal dragging.

(Item 3-5) The working machine 1 according to any one of items 3-1 to 3-4, wherein the correction function includes a proportional component and a derivative component obtained by decomposing the actual angular velocity.

With the working machine 1 according to item 3-5, the controller 4 is configured or programmed to use a proportional component and a derivative component obtained by decomposing the actual angular velocity as the correction function and apply it directly or indirectly to the difference e to obtain the output value, and therefore the output value is highly accurate and corresponds to the actual situation.

(Item 3-6) The working machine 1 according to any one of items 3-1 to 3-4, wherein the controller 4 is configured or programmed to decompose the difference e into a proportional component and an integral component and apply a proportional component and a derivative component of the actual angular velocity to the proportional component and the integral component of the difference e to obtain the output value.

With the working machine 1 according to item 3-6, the controller 4 is configured or programmed to decompose the difference e into a proportional component and an integral component and apply the proportional component and the derivative component of the actual angular velocity to the proportional component and the integral component of the difference e to obtain an output value. Therefore, a highly accurate output value that corresponds to the rotating state of the to-be-measured object is outputted by a short-time process.

(Item 3-7) The working machine 1 according to any one of items 1 to 4, further including a control valve 73 to receive a signal from the controller 4 to control hydraulic fluid supplied to a hydraulic actuator 313, 314, 315 to rotate the to-be-measured object, wherein the controller 4 is configured or programmed to include a subtractor 410 to output the difference e between the target angular velocity and the actual angular velocity, an integrator 411 to determine an integral component of the difference e output by the subtractor 410, a first proportional determiner 412 to determine a proportional component of the difference e output by the subtractor 410, a second proportional determiner 413 to determine a proportional component of the actual angular velocity, a differentiator 414 to determine a derivative component of the actual angular velocity, and an adder-subtractor 415 to perform addition and subtraction of outputs of the integrator 411, the first proportional determiner 412, the second proportional determiner 413, and/or the differentiator 414, and the controller 4 is configured or programmed to output an output value from the adder-subtractor 415 as the signal for the control valve 73.

With the working machine 1 according to item 3-7, the controller 4 is configured or programmed to include an integrator 411 to determine an integral component of the difference e and a first proportional determiner 412 to determine a proportional component of the difference e output by the subtractor 410, and therefore the difference e output by the subtractor 410 is decomposed into a proportional component and an integral component. Furthermore, the controller 4 is configured or programmed to include a second proportional determiner 413 to determine a proportional component of the actual angular velocity, a differentiator 414 to determine a derivative component of the actual angular velocity, and an adder-subtractor 415 to perform addition and subtraction of the outputs from the integrator 411, the first proportional determiner 412, the second proportional determiner 413, and/or the differentiator 414, and therefore the controller 4 is configured or programmed to apply the proportional component and the derivative component of the actual angular velocity to the proportional component and the integral component of the difference e.

Since the controller 4 then outputs the output value u of the adder-subtractor 415 as a signal for the control valve 73, the controller 4 can output a highly accurate output value to the control valve 73 by a short-time process, allowing the to-be-measured object to rotate at an ideal target angular velocity. This prevents or reduces the vibrations of the bucket 312 coupled to the boom 310 via the arm 311, and prevents or reduces the occurrence of hunting in the bucket 312 during horizontal dragging.

(Item 3-8) The working machine 1 according to any one of items 3-1 to 3-7, further including a low-pass filter 47 to remove noise of the rotation sensor 45, 46, 48, wherein the controller 4 is configured or programmed to derive the actual angular velocity using a signal from the low-pass filter 47 as the measurement result from the rotation sensor 45, 46, 48.

Since the working machine 1 according to item 3-8 includes a low-pass filter 47 to remove noise of the rotation sensor(s) 45, 46, 48, a measurement (detection) result transmitted from the rotation sensor 46 to the controller 4 exhibits reduced or no noise. With this, the processing accuracy (the accuracy of deriving the actual angular velocity) of the controller 4 is improved.

(Item 3-9) The working machine 1 according to item 3-8, wherein the low-pass filter 47 includes a 5×5 Gaussian filter.

With the working machine 1 according to item 3-9, the low-pass filter 47 is a 5×5 Gaussian filter, and therefore noise contained in the measurement result from the rotation sensor 46 can be efficiently and reliably removed. With this, the processing accuracy (the accuracy of deriving the actual angular velocity) of the controller 4 is further improved.

(Item 3-10) The working machine 1 according to any one of items 3-1 to 3-9, wherein the rotation sensor 45, 46, 48 includes a potentiometer.

With the working machine 1 according to item 3-10, the rotation sensor(s) 45, 46 is/are potentiometer(s) which is/are angle sensor(s), and therefore the angle (posture) of the to-be-measured object(s) which rotate(s) (change(s) its posture) can be accurately detected. Therefore, the actual angular velocity of the to-be-measured object(s) derived by the controller 4 based on the detection result(s) from the potentiometer(s) 45, 46 is highly accurate.

(Item 4-1) A working machine 1 including a machine body 2, a boom 310 coupled to the machine body 2 such that the boom 310 is rotatable about a first lateral shaft S1, an arm 311 coupled to a distal portion of the boom 310 such that the arm 311 is rotatable about a second lateral shaft S2, a bucket 312 coupled to a distal portion of the arm 311 such that the bucket 312 is rotatable about a third lateral shaft S3 and including an edge portion 312a located away from a junction of the bucket 312 and the arm 311, the edge portion 312a being a leading edge when the bucket 312 excavates earth, the bucket 312 being operable to rotate about the third lateral shaft S3 in one direction to swing toward the machine body 2 such that the edge portion 312a, which is the leading edge, excavates earth and being operable to rotate about the third lateral shaft S3 in an opposite direction to be in a posture to discharge earth, and a controller 4 configured or programmed to control rotation of the boom 310 and the arm 311, wherein the controller 4 is configured or programmed to restrict rotation of the bucket 312 in the one direction when (i) a distance between a target excavation surface which is a plane corresponding to the target excavation depth and an axis of the third lateral shaft S3 is shorter than a distance between the axis of the third lateral shaft S3 and the edge portion 312a and (ii) the edge portion 312a is located in one of two regions separated by an imaginary planar first boundary B1 that is farther away from the machine body 2 than the other of the two regions, the first boundary B1 being perpendicular to the target excavation surface and including the axis of the third lateral shaft S3.

With the working machine 1 according to item 4-1, the controller 4 is configured or programmed to restrict rotation of the bucket 312 in the one direction when (i) the distance between a target excavation surface which is a plane corresponding to the target excavation depth and the axis of the third lateral shaft S3 is shorter than the distance between the axis of the third lateral shaft S3 and the edge portion 312a and (ii) the edge portion 312a is located in one of two regions separated by an imaginary planar first boundary B1 that is farther away from the machine body 2 than the other of the two regions, the first boundary B1 being perpendicular to the target excavation surface and including the axis of the third lateral shaft S3.

Note that, in the subject-matter according to items 4, the wording “restrict rotation” refers to eliminating the likelihood that the bucket 312 will rotate as rated, and can refer to causing the bucket 312 to rotate such that the angular velocity of the bucket 312 about the third lateral shaft S3 gradually decreases from the angular velocity at the rated output condition or causing the bucket 312 to rotate at an angular velocity lower than the angular velocity at the rated output condition. Therefore, with the working machine 1 according to item 4-1, it is possible to eliminate or reduce the likelihood that the edge portion 312a of the bucket 312 will excavate deeper than the target excavation depth.

Specifically, under the conditions in which an imaginary straight line connecting the second lateral shaft S2 and the edge portion 312a of the bucket 312 is vertical or substantially vertical, in the current state of the boom 310 regardless of the posture (angle) of the boom 310, the edge portion 312a of the bucket 312 is positioned at the lowest point.

Thus, by restricting the rotation of the bucket 312 in the one direction when (i) the distance between a target excavation surface which is a plane corresponding to the target excavation depth and the axis of the third lateral shaft S3 is shorter than the distance between the axis of the third lateral shaft S3 and the edge portion 312a and (ii) the edge portion 312a is located in one of two regions separated by an imaginary planar first boundary B1 (which is perpendicular to the target excavation surface and including the axis of the third lateral shaft S3) that is farther away from the machine body 2 than the other of the two regions, it is possible to eliminate or reduce the likelihood that the edge portion 312a of the bucket 312 will move toward the lowest point with no limitations (will excavate too deep). In other words, the edge portion 312a of the bucket 312 is braked, eliminating or reducing the likelihood that the edge portion 312a will move deeper than the target excavation depth.

(Item 4-2) The working machine 1 according to item 4-1, the controller (4) is configured or programmed to not restrict the rotation of the bucket (312) in the one direction when the edge portion (312a) is positioned in the other of the two regions that is closer to the machine body (2) than the first boundary (B1) or when the edge portion (312a) is positioned in the other of the two regions closer to the machine body (2) than the first boundary (B1) and higher than the target excavation surface.

With the working machine 1 according to item 4-2, the controller 4 is configured or programmed to not restrict the rotation of the bucket 312 in the one direction when the edge portion 312a is positioned in the other of the two regions that is closer to the machine body 2 than the first boundary B1 or when the edge portion 312a is positioned in the other of the two regions that is closer to the machine body 2 than the first boundary B1 and higher than the target excavation surface, and therefore, under the conditions in which the bucket 312 is not likely to excavate too deep, the bucket 312 can be rotated without restrictions. In other words, under the conditions in which the bucket 312 is not likely to excavate too deep, the bucket 312 rotates as usual (as rated), making it possible to prevent or reduce a reduction in work efficiency.

(Item 4-3) The working machine 1 according to item 4-1 or 4-2, wherein the controller 4 is configured or programmed to not restrict the rotation of the bucket 312 in the one direction when the distance between the target excavation surface and the axis of the third lateral shaft S3 is longer than the distance between the axis of the third lateral shaft S3 and the edge portion 312a.

With the working machine 1 according to item 4-3, the controller 4 is configured or programmed to not restrict the rotation of the bucket 312 in the one direction when the distance between the target excavation surface and the axis of the third lateral shaft S3 is longer than the distance between the axis of the third lateral shaft S3 and the edge portion 312a, and therefore, under the conditions in which the bucket 312 is not likely to excavate too deep, the bucket 312 can be rotated without restrictions. In other words, under the conditions in which the bucket 312 is not likely to excavate too deep, the bucket 312 rotates as usual (as rated), making it possible to prevent or reduce a reduction in work efficiency.

(Item 4-4) The working machine 1 according to any one of items 4-1 to 4-3, wherein restricting the rotation of the bucket 312 in the one direction by the controller 4 includes setting an upper limit of an angular velocity of the bucket 312 about the third lateral shaft S3 such that the upper limit decreases as a distance between a current position of the edge portion 312a and the target excavation surface decreases.

With the working machine 1 according to item 4-4, restricting the rotation of the bucket 312 in the one direction by the controller 4 includes setting an upper limit of an angular velocity of the bucket 312 about the third lateral shaft S3 such that the upper limit decreases as the distance between the current position of the edge portion 312a and the target excavation surface decreases, making it possible to rotate the bucket 312 at an angular velocity corresponding to the position of the edge portion 312a, and possible to eliminate or reduce the likelihood that the bucket 312 will excavate deeper than the target excavation depth.

(Item 4-5) The working machine 1 according to any one of items 4-1 to 4-3, wherein restricting the rotation of the bucket 312 in the one direction by the controller 4 includes prohibiting the rotation of the bucket 312 in the one direction.

With the working machine 1 according to item 4-5, restricting the rotation of the bucket 312 in the one direction by the controller 4 is prohibiting the rotation of the bucket 312 in the one direction, making it possible to reliably prevent or reduce the likelihood that the bucket 312 will excavate deeper than the target excavation depth.

The present invention is not limited to the above-described example embodiments, and suitable modifications may be made within the gist of the present invention.

For example, in the first example embodiment and the second example embodiment, although the two output forms, which are the high-rotational-speed, high-power mode (HI mode) and the low-rotational-speed, low-power mode (LOW mode), are set as engine output forms, the present invention is not limited to these modes. For example, an output form that is one of high output (HI) and low output (LOW) may be the output form of the engine. Alternatively, the output forms of the engine may include, in addition to the high output (HI) and the low output (LOW), at least one mid output (MID) between the high output (HI) and the low output (LOW). In addition, the output form of the engine may be made variable either stepwise or continuously between the high output (HI) and the low output (LOW). In this case, a first target angular velocity may be derived through linear interpolation between the high output (HI) and the low output (LOW).

In the first example embodiment and the second example embodiment, although the process is switched from the former process to the latter process, the present invention is not limited to this. For example, the former process may be continuously performed without switching from the former process that is performed at the time of activation to the latter process.

In the first example embodiment and the second example embodiment, although the combination of the former process and the latter process has been mentioned as an example, the present invention is not limited to this. For example, other latter processes may be combined with the former process, which has been described in the first example embodiment and the second example embodiment. Other former processes may be combined with the latter process, which has been described in the first example embodiment and the second example embodiment.

In the first example embodiment and the second example embodiment, although the limitation process for the bucket 312 has been performed in addition to the former process and the latter process, the present invention is not limited to this. The limitation process for the bucket 312 may be combined with a process other than the combination of the former process and the latter process in each of the above example embodiments, or only the limitation process for the bucket 312 may be performed.

In the first example embodiment and the second example embodiment, although the dozer 30 is provided as the working device 3, the present invention is not limited to this. For example, only the shovel 31 may be provided as the working device 3. Although not specifically mentioned in each of the above-described example embodiments, the bucket 312 may be a typical bucket that performs shoveling and discharging (dumping) may be the bucket 312 equipped with a sieve that can sort materials by particle size in accordance with the shoveling.

In the first example embodiment and the second example embodiment, although an electromagnetic proportional directional flow control valve that is capable of switching the flow direction (flow path) of the hydraulic fluid and adjusting the flow rate of the hydraulic fluid to be circulated is used as the control valve 73 of the valve unit 72, the present invention is not limited to this. For example, in the hydraulic system 7, a solenoid-type directional valve to switch the flow path of the hydraulic fluid and a solenoid-type flow regulating valve to adjust the flow rate of the hydraulic fluid may be arranged separately and independently. Also in this case, as the flow regulating valve that adjusts the flow rate of the hydraulic fluid, a valve that changes the flow rate of the hydraulic fluid in accordance with the value of the current input to the solenoids 732 and 732 is used.

In the first example embodiment and the second example embodiment, the relationship between the angle of the boom 310, the angle of the arm 311, and the position (height) of the edge portion 312a of the bucket 312 is stored in the storing unit 40 as the table (map) T1, and the controller 4 (the calculator 41) derives the position (height) of the edge portion 312a of the bucket 312 based on the combination of the angle of the boom 310 and the angle of the arm 311 stored in the storing unit 40. However, the present invention is not limited to this. For example, the relationship between the angle of the boom 310, the angle of the arm 311, and the position (height) of the edge portion 312a of the bucket 312 can be derived by using a trigonometric function, and thus, the controller 4 (the calculator 41) may calculate the position (height) of the edge portion 312a of the bucket 312 based on the angles of the boom 310 and the arm 311 that are actually measured.

In the first example embodiment and the second example embodiment, the output limit maps (the output limit map for high output and the output limit map for low output) that define the output limit of the bucket 312 are set such that, even in a state where the position of the edge portion 312a of the bucket 312 and the target excavation depth position TL coincide with each other (the distance between them is 0 (zero)), the angular velocity of the bucket 312 is set, allowing the bucket 312 to rotate. However, the present invention is not limited to this. For example, in a state where the position of the edge portion 312a of the bucket 312 and the target excavation depth position TL coincide with each other (the distance between them is 0 (zero)), the output limit maps (the output limit map for high output and the output limit map for low output) that define the output limit of the bucket 312 may set the output of the bucket 312 to 0 (zero). Even in this case, when the boom 310 rises, the bucket 312 is lifted up, and the difference between the position of the edge portion 312a of the bucket 312 and the target excavation depth position TL gradually increases. Therefore, the bucket 312 may be rotated at an angular velocity that corresponds to the difference (an angular velocity that varies with the change).

In the first example embodiment and the second example embodiment, although an internal combustion engine (a diesel engine) is used as the driving source 78 that drives the hydraulic pump 71, the driving source 78 is not limited to this. For example, the driving source 78 may be an electric motor.

In the above-described second example embodiment, the angular acceleration (slope of angular velocity) of the boom 310 is derived based on the angles of the tangents TL1 to TL5 (tangents TL1 to TL5 angles) to the path (imaginary arc VC) of the edge portion 312a of the bucket 312 when the arm 311 rotates while the second lateral shaft S2 functions as a rotation fulcrum in a state where the bucket 312 is positioned at the dump end. However, the present invention is not limited to this. For example, in the automatic excavation mode, when the bucket 312 is located at a specific position (angle) that is different from the dump end, the angular acceleration (slope of angular velocity) of the boom 310 may be derived based on the angles of the tangents TL1 to TL5 (tangents TL1 to TL5 angles) to the path (imaginary arc VC) of the edge portion 312a of the bucket 312 when the arm rotates while the second lateral shaft S2 functions as a rotation fulcrum in a state where the bucket 312 is located at the specific position.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A working machine comprising:
a machine body;
a boom coupled to the machine body such that the boom is rotatable about a first lateral shaft;
an arm coupled to a distal portion of the boom such that the arm is rotatable about a second lateral shaft;
a bucket coupled to a distal portion of the arm and including an edge portion located away from a junction of the bucket and the arm, the edge portion being a leading edge when the bucket excavates earth; and
a controller configured or programmed to control rotation of the boom and the arm; wherein
the controller is configured or programmed to, in performing a first process in which the controller causes the arm to rotate about the second lateral shaft toward the boom while causing the boom to rotate about the first lateral shaft to move up to perform excavation along a plane at a target excavation depth:
set a first target angular velocity of the arm and a second target angular velocity of the boom based on a distance between the edge portion in a movement start position and the target excavation depth, the first target angular velocity being a target angular velocity corresponding to a period of time elapsed from a start of movement of the arm, the second target angular velocity being a target angular velocity corresponding to a period of time elapsed from a start of movement of the boom; and
control rotation of the arm and the boom based on the set first target angular velocity and the set second target angular velocity.

2. The working machine according to claim 1, wherein
the controller is configured or programmed to:
set the first target angular velocity such that, as the distance becomes smaller, an initial angular velocity of the arm becomes smaller and an angular acceleration during a predetermined first period of time elapsed from the start of movement becomes greater; and
set the second target angular velocity according to the first target angular velocity.

3. The working machine according to claim 2, wherein
the controller is configured or programmed to set the first target angular velocity such that the first target angular velocity increases during the first period of time elapsed from the start of movement and is constant after the first period of time has elapsed.

4. The working machine according to claim 1, wherein
the controller is configured or programmed to set the second target angular velocity such that the second target angular velocity increases during a second period of time elapsed from the start of movement and is constant after the second period of time has elapsed, and set the second period of time such that the second period of time becomes longer as the distance becomes greater.

5. The working machine according to claim 1, further comprising:
an arm cylinder to extend and retract by receiving and discharging hydraulic fluid to rotate the arm;
a boom cylinder to extend and retract by receiving and discharging hydraulic fluid to rotate the boom;
an arm control valve including a solenoid to switch supplying and discharging hydraulic fluid to and from the arm cylinder and to adjust a flow rate of hydraulic fluid based on a current value inputted thereto; and
a boom control valve including a solenoid to switch supplying and discharging hydraulic fluid to and from the boom cylinder and to adjust a flow rate of hydraulic fluid based on a current value inputted thereto; wherein
the controller is configured or programmed to supply a current corresponding to the first target angular velocity to the solenoid of the arm control valve and supply a current corresponding to the second target angular velocity to the solenoid of the boom control valve.

6. The working machine according to claim 5, further comprising:
a hydraulic pump to deliver hydraulic fluid toward the arm cylinder and the boom cylinder; and
a driving source to drive the hydraulic pump; wherein
the controller is configured or programmed to, when performing the first process, set the first target angular velocity and the second target angular velocity based on a distance between the edge portion and the target excavation depth and an output of the driving source at a time of receipt of an instruction to actuate the arm and the boom.

7. The working machine according to claim 6, wherein
the driving source is operable to switch a power mode thereof between:
a low-power mode in which the driving source produces output in a low-power range included in a power range thereof, and
a high-power mode in which the driving source produces output higher than the low-power range included in the power range thereof, and
the controller is configured or programmed to, when performing the first process, set the first target angular velocity and the second target angular velocity based on the distance between the edge portion and the target excavation depth and the power mode of the driving source at a time of receipt of an instruction to actuate the arm and the boom.

8. The working machine according to claim 7, wherein
the controller is configured or programmed to:
set an initial angular velocity of the arm using Equation (1) below;
set a rate of increase of an angular velocity of the arm during a predetermined period of time elapsed from the start of movement using Equation (2) below; and
set the first target angular velocity during the predetermined period of time elapsed from the start of movement using Equation (3) below:
Initial angular velocity ωs=(P×k)−Nd Equation (1)
Rate of increase α of angular velocity=(ωmax−ωs)/Ta Equation (2)
First target acceleration=α×Tb+ωs Equation (3),
where P represents the distance between the edge portion and the target excavation depth at a time of the start of movement,
k represents a preset coefficient,
Nd represents a difference of the output of the driving source from an output in the high-power mode,
ωmax represents an estimated maximum angular velocity of the arm corresponding to the output of the driving source,
Ta represents time taken to reach the maximum angular velocity, and
Tb represents the period of time elapsed from the start of movement.

9. The working machine according to claim 1, wherein
the controller is configured or programmed to derive the second target angular velocity by multiplying the first target angular velocity by a predetermined reflection coefficient set such that the second target angular velocity is lower than the first target angular velocity.

10. The working machine according to claim 1, wherein
the controller is configured or programmed to:
include a memory and/or a storage to store (i) a plurality of combinations of an initial difference and initial angle information and (ii) set values of angular acceleration of the boom about the first lateral shaft that correspond to the plurality of combinations, the initial difference being a distance between a target excavation surface and the edge portion in the movement start position in the first process, the target excavation surface being a plane corresponding to the target excavation depth, the first process being a process in which the controller causes the arm to rotate about the second lateral shaft toward the boom while causing the boom to rotate about the first lateral shaft to move up to perform excavation along the plane at the target excavation depth, the initial angle information being correlated with an angle of the arm relative to the target excavation surface when the edge portion is in the movement start position; and
set, based on one of the set values that corresponds to a corresponding combination of the initial difference and the initial angle information when the edge portion is in the movement start position, an angular acceleration of the boom about the first lateral shaft during a predetermined period of time elapsed from the start of rotation, and control rotation of the boom based on the set angular acceleration.

11. A working machine comprising:
a machine body;
a boom coupled to the machine body such that the boom is rotatable about a first lateral shaft;
an arm coupled to a distal portion of the boom such that the arm is rotatable about a second lateral shaft;
a bucket coupled to a distal portion of the arm and including an edge portion located away from a junction of the bucket and the arm, the edge portion being a leading edge when the bucket excavates earth; and
a controller configured or programmed to control rotation of the boom and the arm; wherein
the controller is configured or programmed to:
include a memory and/or a storage to store (i) a plurality of combinations of an initial difference and initial angle information and (ii) set values of angular acceleration of the boom about the first lateral shaft that correspond to the plurality of combinations, the initial difference being a distance between a target excavation surface and the edge portion in a movement start position in a first process, the target excavation surface being a plane corresponding to a target excavation depth, the first process being a process in which the controller causes the arm to rotate about the second lateral shaft toward the boom while causing the boom to rotate about the first lateral shaft to move up to perform excavation along a plane at the target excavation depth, the initial angle information being correlated with an angle of the arm in the movement start position relative to the target excavation surface; and
set, based on one of the set values that corresponds to a corresponding combination of the initial difference and the initial angle information when the arm is in the movement start position, an angular acceleration of the boom about the first lateral shaft during a predetermined period of time elapsed from a start of movement, and control rotation of the boom based on the set angular acceleration.

12. The working machine according to claim 10, wherein
the initial angle information includes an initial tangent angle indicating an angle, relative to the target excavation surface when the edge portion is in the movement start position, of a tangent to an imaginary circle defined by a path of movement of the edge portion of the bucket around the second lateral shaft.

13. The working machine according to claim 12, wherein the set values of angular acceleration stored in the memory and/or the storage are set greater for smaller initial differences and set greater for larger initial tangent angles.

14. The working machine according to claim 10, further comprising:
a boom angle detector to detect an angle of rotation of the boom about the first lateral shaft with respect to the machine body; and
an arm angle detector to detect an angle of rotation of the arm about the second lateral shaft with respect to the boom; wherein
the controller is configured or programmed to calculate the initial angle information based on a detection result from the boom angle detector, a detection result from the arm angle detector, and the target excavation depth.

15. The working machine according to claim 10, wherein
the bucket is coupled to the distal portion of the arm such that the bucket is rotatable about a third lateral shaft;
the working machine further comprises a bucket angle detector to detect an angle of rotation of the bucket about the third lateral shaft with respect to the arm; and
the controller is configured or programmed to calculate the initial angle information based on a detection result from a boom angle detector, a detection result from an arm angle detector, a detection result from the bucket angle detector, and the target excavation depth.

16. The working machine according to claim 10, wherein the controller is configured or programmed to, if a value of the angular acceleration corresponding to a combination of the actual initial difference and the actual initial angle information when the arm is in the movement start position is other than the set values stored in the memory and/or the storage, interpolate a set value of the angular acceleration corresponding to the combination of the actual initial difference and the initial angle information based on the plurality of combinations of the initial difference and the initial angle information stored in the memory and/or the storage and set values of the angular velocity that correspond to the plurality of combinations.

17. The working machine according to claim 1, wherein
the bucket is coupled to the distal portion of the arm such that the bucket is rotatable about a third lateral shaft, and includes the edge portion located away from the junction of the bucket and the arm, the edge portion being the leading edge when the bucket excavates earth, the bucket being operable to rotate about the third lateral shaft in one direction to swing toward the machine body such that the edge portion, which is the leading edge, excavates earth and being operable to rotate about the third lateral shaft in an opposite direction to be in a posture to discharge earth; and
the controller is configured or programmed to restrict rotation of the bucket in the one direction when (i) a distance between a target excavation surface which is a plane corresponding to the target excavation depth and an axis of the third lateral shaft is shorter than a distance between the axis of the third lateral shaft and the edge portion and (ii) the edge portion is located in one of two regions separated by an imaginary planar first boundary that is farther away from the machine body than the other of the two regions, the first boundary being perpendicular to the target excavation surface and including the axis of the third lateral shaft.

18. A working machine comprising:
a machine body;
a boom coupled to the machine body such that the boom is rotatable about a first lateral shaft;
an arm coupled to a distal portion of the boom such that the arm is rotatable about a second lateral shaft;
a bucket coupled to a distal portion of the arm such that the bucket is rotatable about a third lateral shaft and including an edge portion located away from a junction of the bucket and the arm, the edge portion being a leading edge when the bucket excavates earth, the bucket being operable to rotate about the third lateral shaft in one direction to swing toward the machine body such that the edge portion, which is the leading edge, excavates earth and being operable to rotate about the third lateral shaft in an opposite direction to be in a posture to discharge earth; and
a controller configured or programmed to control rotation of the boom and the arm; wherein
the controller is configured or programmed to restrict rotation of the bucket in the one direction when (i) a distance between a target excavation surface which is a plane corresponding to a target excavation depth and an axis of the third lateral shaft is shorter than a distance between the axis of the third lateral shaft and the edge portion and (ii) the edge portion is located in one of two regions separated by an imaginary planar first boundary that is farther away from the machine body than the other of the two regions, the first boundary being perpendicular to the target excavation surface and including the axis of the third lateral shaft.

19. The working machine according to claim 17, wherein
the controller is configured or programmed to not restrict the rotation of the bucket in the one direction when the edge portion is positioned in the other of the two regions that is closer to the machine body than the first boundary or when the edge portion is positioned in the other of the two regions closer to the machine body than the first boundary and higher than the target excavation surface.

20. The working machine according to claim 17, wherein
the controller is configured or programmed to not restrict the rotation of the bucket in the one direction when the distance between the target excavation surface and the axis of the third lateral shaft is longer than the distance between the axis of the third lateral shaft and the edge portion.
